(19) United States
(12) Patent Application Publication
(10) Pub. No.: US 2020/0218364 A1
(43) Pub. Date: Jul. 9, 2020

(54) ELECTRONIC DEVICE AND METHOD FOR IDENTIFYING INPUT

(71) Applicant: Samsung Electronics Co., Ltd., Suwon-si (KR)

(72) Inventors: Jeonghoon KIM, Suwon-si (KR); Keunsoo KIM, Suwon-si (KR); Sangheon KIM, Suwon-si (KR); Jongwu BAEK, Suwon-si (KR)

(21) Appl. No.: 16/738,832

(22) Filed: Jan. 9, 2020

(30) Foreign Application Priority Data
Jan. 9, 2019 (KR) 10-2019-0002860

(51) Int. Cl. G06F 3/038; G06F 3/0354; G06F 3/02; G06F 3/16; G10L 15/22; G06F 3/0346

(52) U.S. Cl. CPC G06F 3/038; G06F 3/03545; G06F 3/0202; G06F 3/167; H04R 1/02; G06F 3/0346; G06F 2203/0384; G06F 2203/0381; G10L 2015/223; G10L 15/22

(57) ABSTRACT

An electronic device includes a housing, a microphone exposed through a part of the housing, at least one wireless communication circuitry detachably disposed inside the housing and configured to wirelessly connect with a stylus pen which includes a button. The electronic device also includes a processor and a memory for storing instructions. The instructions when executed, cause the processor receive a first radio signal transmitted based on a user input to the button from the stylus pen, activate a voice recognition function of the microphone in response to receiving the first radio signal, receive an audio signal from a user through the microphone, recognize the received audio signal using the activated voice recognition function, and execute a function indicated by the audio signal, based at least in part on the recognition result.

### CROSS-REFERENCE TO RELATED APPLICATION

This application is based on and claims priority under 35 U.S.C. § 119 to Korean Patent Application No. 10-2019-0002860, filed on Jan. 9, 2019, in the Korean Intellectual Property Office, the disclosure of which is incorporated by reference herein in its entirety.

### BACKGROUND

### 1. Field

Various embodiments of the disclosure relate generally to an electronic device for identifying an input and its operating method.

### 2. Description of Related Art

An electronic device including a touch screen is developed to provide intuitive interaction. Such an electronic device may interwork with an input tool such as a digital pen and a stylus.

The electronic device may interwork with the input tool such as a digital pen and a stylus. The electronic device may provide different functions according to an input received from the input tool. Hence, a solution for providing different functions according to the input in the electronic device may be required.

### SUMMARY

An electronic device according to various embodiments may include a housing, a microphone exposed through a part of the housing, at least one wireless communication circuitry disposed to be attached or detached inside the housing and configured to wirelessly connect with a stylus pen which includes a button, a processor disposed in the housing and operatively coupled with the microphone and the wireless communication circuitry, and a memory disposed in the housing, operatively coupled with the processor, and storing instructions, when executed, which cause the processor to receive a first radio signal transmitted based on a user input to the button from the stylus pen through the wireless communication circuitry, activate a voice recognition function of the microphone in response to receiving the first radio signal, receive an audio signal from a user through the microphone, recognize the received audio signal using the activated voice recognition function, and execute a function indicated by the audio signal, based at least in part on the recognition result.

A method for operating an electronic device according to various embodiments may include receiving, a first radio signal transmitted based on a user input to a button from a stylus pen which is detachably disposed in a housing of the electronic device and includes the button, through wireless communication circuitry of the electronic device, activating a voice recognition function of a microphone exposed through a part of the housing of the electronic device, in response to receiving the first radio signal, receiving an audio signal from a user through the microphone, based on the activated recognition function, recognizing the received audio signal using the activated voice recognition function, and executing a function indicated by the audio signal, based at least in part on the recognition result.

Other aspects, advantages, and salient features of the disclosure will become apparent to those skilled in the art from the following detailed description, which, taken in conjunction with the annexed drawings, discloses various embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a block diagram of an integrated intelligence system according to an embodiment;

FIG. 2 illustrates a diagram of relationship information of concepts and actions stored in a database according to an embodiment;

FIG. 3 illustrates a diagram of a user terminal which displays a screen for processing a voice input received through an intelligent app according to an embodiment;

FIG. 4 illustrates a block diagram of an electronic device in a network environment according to various embodiments;

FIG. 5 illustrates a perspective view of an electronic device including a digital pen according to an embodiment;

FIG. 6 illustrates a block diagram of a digital pen according to an embodiment;

FIG. 7 illustrates an exploded view of a digital pen according to an embodiment;

FIG. 8 illustrates a block diagram of an electronic device, a digital pen, and an external electronic device according to various embodiments;

FIG. 9A illustrates an example of operations of an electronic device according to various embodiments;

FIG. 9B illustrates an example of the operations of the electronic device according to various embodiments;

FIG. 9C illustrates an example of the operations of the electronic device according to various embodiments;

FIG. 9D illustrates an example of the operations of the electronic device according to various embodiments;

FIG. 9E illustrates an example of the operations of the electronic device according to various embodiments;

FIG. 10 illustrates a block diagram of an electronic device, a digital pen, and an external electronic device according to various embodiments;

FIG. 11 illustrates a block diagram of an electronic device, a digital pen, and an external electronic device according to various embodiments; and

FIG. 12 illustrates a block diagram of an electronic device, a digital pen, and an external electronic device according to various embodiments.

Throughout the drawings, like reference numerals will be understood to refer to like parts, components and structures.

### DETAILED DESCRIPTION

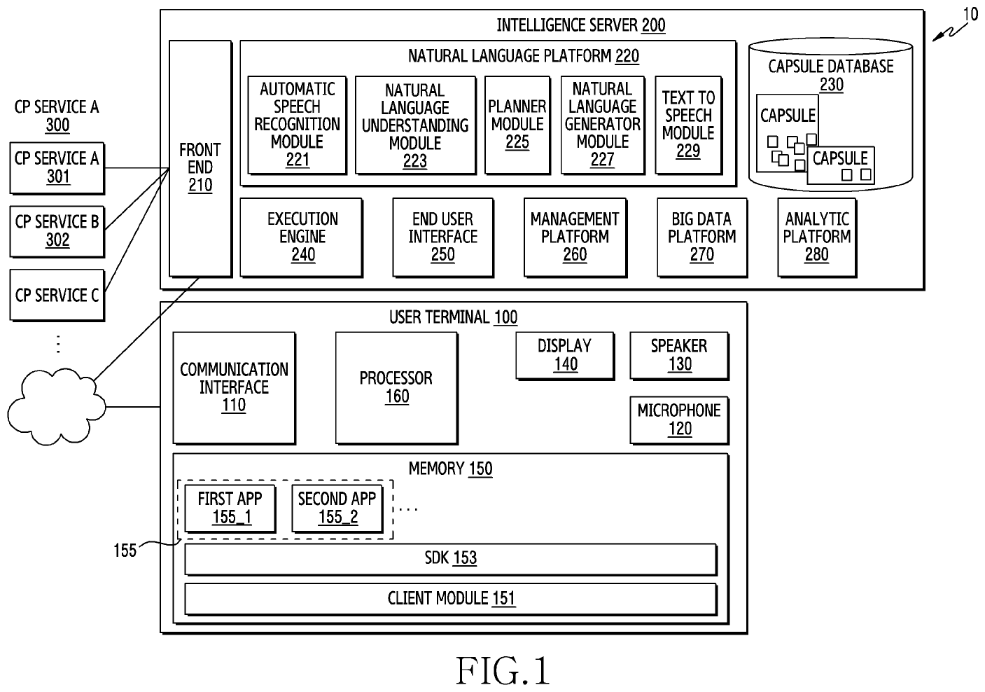

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following descriptions with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms of first, second or the like may be used to explain various constituent elements, but these terms should be interpreted only for the purpose of distinguishing one constituent element from another constituent element. For example, a first constituent element may be named a second constituent element and similarly, a second constituent element may be named a first constituent element as well.

When it is mentioned that any constituent element is “coupled” to another constituent element, the any constituent element may be directly coupled or connected to the another constituent element as well, but it should be understood that a further constituent element may exist in the middle as well.

The expression of a singular form includes the expression of a plural form unless otherwise dictating clearly in context. If the specification, it should be understood that the term “include”, “have” or the like is to designate the existence of explained features, numerals, steps, operations, constituent elements, components or a combination of them, and does not previously exclude the possibility of existence or addition of one or more other features, numerals, steps, operations, constituent elements, components or combinations of them.

Unless defined otherwise, all the terms used herein including the technological or scientific terms have the same meanings as those generally understood by a person having ordinary skill in the art. The terms such as defined in a generally used dictionary should be construed as having meanings coinciding with the contextual meanings of a related technology, and are not construed as having ideal or excessively formal meanings unless defined clearly in the specification.

Embodiments are explained below in detail with reference to the accompanying drawings. The same reference numeral presented in each of the drawings indicates the same member.

FIG. 1 is a block diagram illustrating an integrated intelligence system according to an embodiment of the disclosure.

Referring to FIG. 1, the integrated intelligence system 10 of an embodiment may include a user terminal 100, an intelligence server 200, and a service server 300.

The user terminal 100 of an embodiment may be a terminal device (or an electronic device) possible to be coupled to the Internet and, for example, may be a portable phone, a smart phone, a personal digital assistant (PDA), a notebook computer, a television (TV), a home appliance, a wearable device, a head mounted device (HMD), or a smart speaker.

According to an embodiment illustrated, the user terminal 100 may include a communication interface 110, a microphone 120, a speaker 130, a display 140, a memory 150, or a processor 160. The enumerated constituent elements may be operatively or electrically coupled with each other.

The communication interface 110 of an embodiment may be configured to be coupled with an external device and transmit and/or receive data with the external device. The microphone 120 of an embodiment may receive a sound (e.g., a user utterance) and convert the sound into an electrical signal. The speaker 130 of an embodiment may output an electrical signal as a sound (e.g., a voice). The display 140 of an embodiment may be configured to display an image or video. The display 140 of an embodiment may also display a graphic user interface (GUI) of an executed app (or application program).

The memory 150 of an embodiment may store a client module 151, a software development kit (SDK) 153, and a plurality of apps 155. The client module 151 and the SDK 153 may configure a framework (or solution program) for performing a generic function. Also, the client module 151 or the SDK 153 may configure a framework for processing a voice input.

The plurality of apps 155 stored in the memory 150 of an embodiment may be a program for performing a designated function. According to an embodiment, the plurality of apps 155 may include a first app 155_1 and a second app 155_2. According to an embodiment, the plurality of apps 155 may each include a plurality of actions for performing a designated function. For example, the apps may include an alarm app, a message app, and/or a schedule app. According to an embodiment, the plurality of apps 155 may be executed by the processor 160, and execute at least some of the plurality of actions in sequence.

The processor 160 of an embodiment may control a general operation of the user terminal 100. For example, the processor 160 may be electrically coupled with the communication interface 110, the microphone 120, the speaker 130, and the display 140, and perform a designated operation.

The processor 160 of an embodiment may also execute a program stored in the memory 150, and perform a designated function. For example, the processor 160 may execute at least one of the client module 151 or the SDK 153, and perform a subsequent operation for processing a voice input. The processor 160 may, for example, control operations of the plurality of apps 155 through the SDK 153. An operation of the client module 151 or the SDK 153 explained in the following may be an operation by the execution of the processor 160.

The client module 151 of an embodiment may receive a voice input. For example, the client module 151 may receive a voice signal corresponding to a user utterance which is sensed through the microphone 120. The client module 151 may transmit the received voice input to the intelligence server 200. The client module 151 may transmit state information of the user terminal 100 to the intelligence server 200, together with the received voice input. The state information may be, for example, app execution state information.

The client module 151 of an embodiment may receive a result corresponding to the received voice input. For example, in response to the intelligence server 200 being capable of calculating the result corresponding to the received voice input, the client module 151 may receive the result corresponding to the received voice input from the intelligence server 200. The client module 151 may display the received result on the display 140.

The client module 151 of an embodiment may receive a plan corresponding to the received voice input. The client module 151 may display, on the display 140, a result of executing a plurality of actions of an app according to the plan. The client module 151 may, for example, display the result of execution of the plurality of actions in sequence on the display. The user terminal 100 may, for another example, display only a partial result (e.g., a result of the last operation) of executing the plurality of actions on the display.

According to an embodiment, the client module 151 may receive a request for obtaining information necessary for calculating a result corresponding to a voice input, from the intelligence server 200. According to an embodiment, in response to the request, the client module 151 may transmit the necessary information to the intelligence server 200.

The client module 151 of an embodiment may transmit result information of executing a plurality of actions according to a plan, to the intelligence server 200. By using the result information, the intelligence server 200 may identify that the received voice input is processed rightly.

The client module 151 of an embodiment may include a voice recognition module. According to an embodiment, the client module 151 may recognize a voice input of performing a restricted function through the voice recognition module. For example, the client module 151 may perform an intelligence app for processing a voice input for performing a systematic operation through a designated input (e.g., wake up!).

The intelligence server 200 of an embodiment may receive information related with a user voice input from the user terminal 100 through a communication network. According to an embodiment, the intelligence server 200 may convert data related with the received voice input into text data. According to an embodiment, the intelligence server 200 may generate a plan for performing a task corresponding to the user voice input on the basis of the text data.

According to an embodiment, the plan may be generated by an artificial intelligent (AI) system. The artificial intelligent system may be a rule-based system as well, and may be a neural network-based system (e.g., feedforward neural network (FNN)) and/or a recurrent neural network (RNN)) as well. Or, the artificial intelligent system may be either a combination of the aforementioned or an artificial intelligent system different from this as well. According to an embodiment, the plan may be selected in a set of predefined plans, or may be generated in real time in response to a user request. For example, the artificial intelligent system may select at least one plan among a predefined plurality of plans.

The intelligent server 200 of an embodiment may transmit a result of the generated plan to the user terminal 100, or transmit the generated plan to the user terminal 100. According to an embodiment, the user terminal 100 may display the result of the plan on the display 140. According to an embodiment, the user terminal 100 may display a result of executing an action of the plan on the display 140.

The intelligent server 200 of an embodiment may include a front end 210, a natural language platform 220, a capsule database (DB) 230, an execution engine 240, an end user interface 250, a management platform 260, a big data platform 270, or an analytic platform 280.

The front end 210 of an embodiment may receive a voice input received from the user terminal 100. The front end 210 may transmit a response corresponding to the voice input.

According to an embodiment, the natural language platform 220 may include an automatic speech recognition module (ASR module) 221, a natural language understanding module (NLU module) 223, a planner module 225, a natural language generator module (NLG module) 227 or a text to speech module (TTS module) 229.

The automatic speech recognition module 221 of an embodiment may convert a voice input received from the user terminal 100 into text data. By using the text data of the voice input, the natural language understanding module 223 of an embodiment may grasp a user's intention. For example, by performing syntactic analysis or semantic analysis, the natural language understanding module 223 may grasp the user's intention. By using a linguistic feature e.g., syntactic factor) of a morpheme or phrase, the natural language understanding module 223 of an embodiment may grasp a meaning of a word extracted from the voice input, and match the grasped meaning of the word with the user intention, to identify the user's intention.

By using an intention and parameter identified by the natural language understanding module 223, the planner module 225 of an embodiment may generate a plan. According to an embodiment, on the basis of the identified intention, the planner module 225 may identify a plurality of domains necessary for performing a task. The planner module 225 may identify a plurality of actions included in each of the plurality of domains which are identified on the basis of the intention. According to an embodiment, the planner module 225 may identify a parameter necessary for executing the identified plurality of actions, or a result value outputted by the execution of the plurality of actions. The parameter and the result value may be defined with a concept of a designated form (or class). Accordingly, the plan may include the plurality of actions identified by the user's intention, and a plurality of concepts. The planner module 225 may identify a relationship between the plurality of actions and the plurality of concepts stepwise (or hierarchically). For example, on the basis of the plurality of concepts, the planner module 225 may identify a sequence of execution of the plurality of actions that are identified on the basis of the user intention. In other words, the planner module 225 may identify the sequence of execution of the plurality of actions, on the basis of the parameter necessary for execution of the plurality of actions and the result outputted by execution of the plurality of actions. Accordingly, the planner module 225 may generate a plan including association information (e.g., ontology) between the plurality of actions and the plurality of concepts. The planner module 225 may generate the plan by using information stored in a capsule database 230 in which a set of relationships between the concept and the action is stored.

The natural language generator module 227 of an embodiment may convert designated information into a text form. The information converted into the text form may be a form of a natural language speech. The text to voice conversion module 229 of an embodiment may convert the information of the text form into information of a voice form.

According to an embodiment, a partial function or whole function of a function of the natural language platform 220 may be implemented even in the user terminal 100.

The capsule database 230 may store information about a relationship between a plurality of concepts and actions corresponding to a plurality of domains. A capsule of an embodiment may include a plurality of action objects (or action information) and concept objects (or concept information) which are included in a plan. According to an embodiment, the capsule database 230 may store a plurality of capsules in a form of a concept action network (CAN). According to an embodiment, the plurality of capsules may be stored in a function registry included in the capsule database 230.

The capsule database 230 may include a strategy registry storing strategy information which is necessary for identifying a plan corresponding to a voice input. The strategy information may include reference information for, in response to there being a plurality of plans corresponding to a voice input, identifying one plan. According to an embodiment, the capsule database 230 may include a follow up registry storing follow-up operation information for proposing a follow-up operation to a user in a designated condition. The follow-up operation may include, for example, a follow-up utterance. According to an embodiment, the capsule database 230 may include a layout registry storing layout information of information outputted through the user terminal 100. According to an embodiment, the capsule database 230 may include a vocabulary registry storing vocabulary information included in capsule information. According to an embodiment, the capsule database 230 may include a dialog registry storing user's dialog (or interaction) information. The capsule database 230 may update an object stored through a developer tool. The developer tool may include, for example, a function editor for updating an action object or a concept object. The developer tool may include a vocabulary editor for updating a vocabulary. The developer tool may include a strategy editor generating and registering a strategy of identifying a plan. The developer tool may include a dialog editor generating a dialog with a user. The developer tool may include a follow up editor which may edit a follow up speech activating a follow up target and providing a hint. The follow up target may be identified on the basis of a currently set target, a user's preference or an environment condition. In an embodiment, the capsule database 230 may be implemented even in the user terminal 100.

The execution engine 240 of an embodiment may calculate a result by using the generated plan. The end user interface 250 may transmit the calculated result to the user terminal 100. Accordingly, the user terminal 100 may receive the result, and provide the received result to a user. The management platform 260 of an embodiment may manage information used in the intelligence server 200. The big data platform 270 of an embodiment may collect user's data. The analysis platform 280 of an embodiment may manage a quality of service (QoS) of the intelligence server 200. For example, the analysis platform 280 may manage a constituent element and processing speed (or efficiency) of the intelligence server 200.

The service server 300 of an embodiment may provide a designated service (e.g., food order or hotel reservation) to the user terminal 100. According to embodiment, the service server 300 may be a server managed by a third party. The service server 300 of an embodiment may provide information for generating a plan corresponding to a received voice input, to the intelligence server 200. The provided information may be stored in the capsule database 230. Also, the service server 300 may provide result information of the plan to the intelligence server 200.

In the above-described integrated intelligence system 10, in response to a user input, the user terminal 100 may provide various intelligent services to the user. The user input may include, for example, an input through a physical button, a touch input or a voice input.

In an embodiment, the user terminal 100 may provide a voice recognition service through an intelligence app (or a voice recognition app) stored therein. In this case, for example, the user terminal 100 may recognize a user utterance or voice input received through the microphone, and provide a service corresponding to the recognized voice input, to the user.

In an embodiment, the user terminal 100 may perform a designated operation, singly, or together with the intelligence server and/or the service server, on the basis of a received voice input. For example, the user terminal 100 may execute an app corresponding to the received voice input, and perform a designated operation through the executed app.

In an embodiment, in response to the user terminal 100 providing a service together with the intelligence server 200 and/or the service server, the user terminal 100 may sense a user utterance by using the microphone 120, and generate a signal (or voice data) corresponding to the sensed user utterance. The user terminal 100 may transmit the voice data to the intelligence server 200 by using the communication interface 110.

As a response to a voice input received from the user terminal 100, the intelligence server 200 of an embodiment may generate a plan for performing a task corresponding to the voice input, or a result of performing an action according to the plan. The plan may include, for example, a plurality of actions for performing a task corresponding to a user's voice input, and a plurality of concepts related with the plurality of actions. The concept may be a definition of a parameter inputted by execution of the plurality of actions or a result value outputted by the execution of the plurality of actions. The plan may include association information between the plurality of actions and the plurality of concepts.

The user terminal 100 of an embodiment may receive the response by using the communication interface 110. The user terminal 100 may output a voice signal generated by the user terminal 100 to the external by using the speaker 130, or output an image generated by the user terminal 100 to the external by using the display 140.

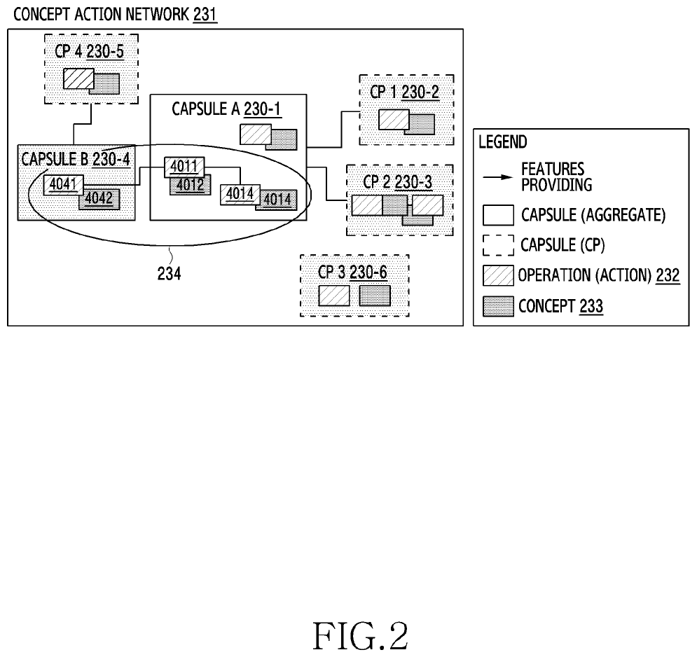

FIG. 2 is a diagram illustrating a form in which relationship information of a concept and an action is stored in a database, according to an embodiment of the disclosure.

Referring to FIG. 2, a capsule database (e.g., the capsule database 230) of the intelligence server 200 may store a capsule in the form of a concept action network (CAN) 231. The capsule database may store an action for processing a task corresponding to a user's voice input and a parameter necessary for the action, in the form of the concept action network (CAN) 231.

The capsule database may store a plurality of capsules (i.e., a capsule A 230-1 and a capsule B 230-4) corresponding to each of a plurality of domains (e.g., applications). According to an embodiment, one capsule (e.g., the capsule A 230-1) may correspond to one domain (e.g., a location (geo) and/or an application). Also, one capsule may correspond to at least one service provider (e.g., a CP 1 230-2 or a CP 2 230-3) for performing a function of a domain related with the capsule. According to an embodiment, one capsule may include at least one or more actions 232 and at least one or more concepts 233, for performing a designated function.

By using a capsule stored in a capsule database, the natural language platform 220 may generate a plan for performing a task corresponding to a received voice input. For example, by using the capsule stored in the capsule database, the planner module 225 of the natural language platform 220 may generate the plan. For example, the planner module 225 may generate a plan 234 by using actions 4011 and 4013 and concepts 4012 and 4014 of a capsule A 230-1 and an action 4041 and concept 4042 of a capsule B 230-4.

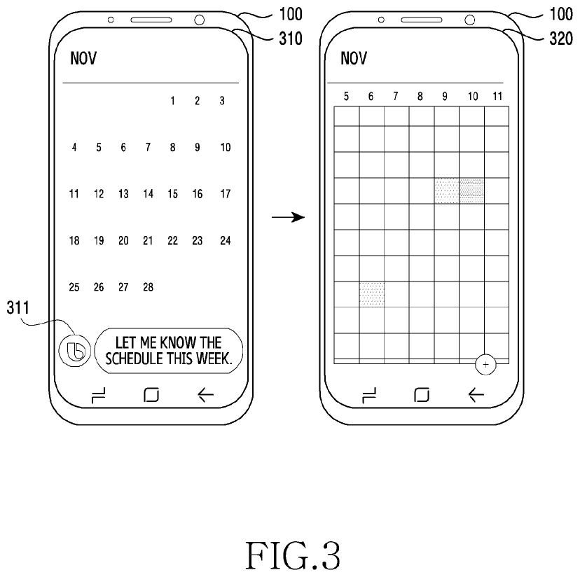

FIG. 3 is a diagram illustrating a screen in which a user terminal processes a received voice input through an intelligence app according to an embodiment of the disclosure.

To process a user input through the intelligence server 200, the user terminal 100 may execute the intelligence app.

According to an embodiment, in screen 310, in response to recognizing a designated voice input (e.g., wake up!) or receiving an input through a hardware key (e.g., a dedicated hardware key), the user terminal 100 may execute the intelligence app for processing the voice input. The user terminal 100 may, for example, execute the intelligence app in a state of executing a schedule app. According to an embodiment, the user terminal 100 may display an object (e.g., an icon) 311 corresponding to the intelligence app on the display 140. According to an embodiment, the user terminal 100 may receive a user input by a user speech. For example, the user terminal 100 may receive a voice input “Let me know a schedule this week!”. According to an embodiment, the user terminal 100 may display a user interface (UI) 313 (e.g., an input window) of the intelligence app in which text data of the received voice input is displayed, on the display.

According to an embodiment, in screen 320, the user terminal 100 may display a result corresponding to be received voice input on the display. For example, the user terminal 100 may receive a plan corresponding to the received user input, and display, on the display, ‘a schedule this week’ according to the plan.

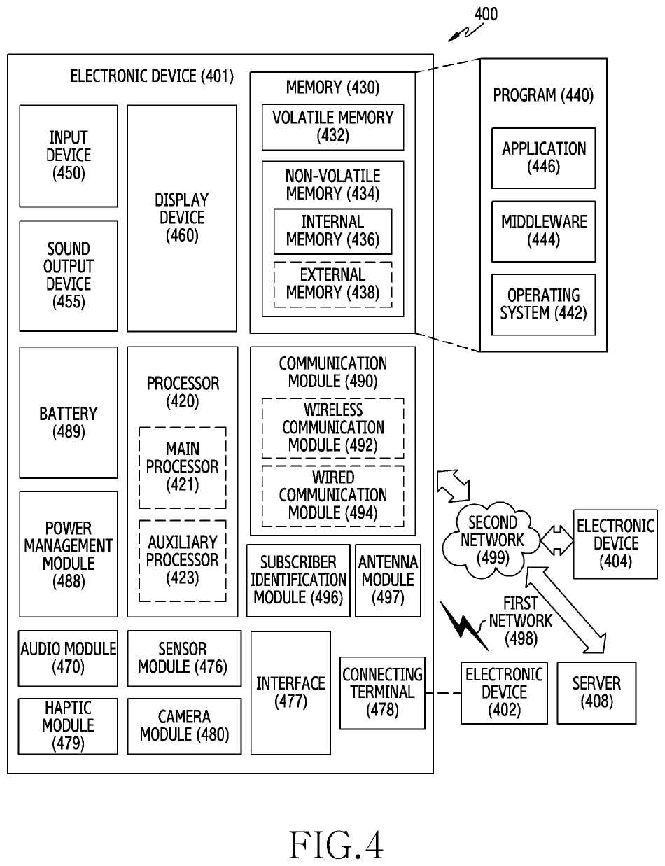

FIG. 4 is a block diagram illustrating an electronic device 401 in a network environment 400 according to an embodiment of the disclosure.

Referring to FIG. 4, the electronic device 401 in the network environment 400 may communicate with an electronic device 402 via a first network 498 (e.g., a short-range wireless communication network), or an electronic device 404 or a server 408 via a second network 499 (e.g., a long-range wireless communication network). According to an embodiment, the electronic device 401 may communicate with the electronic device 404 via the server 408. According to an embodiment, the electronic device 401 may include a processor 420, memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) 496, or an antenna module 497. In some embodiments, at least one (e.g., the display device 460 or the camera module 480) of the components may be omitted from the electronic device 401, or one or more other components may be added in the electronic device 401. In some embodiments, some of the components may be implemented as single integrated circuitry. For example, the sensor module 476 (e.g., a fingerprint sensor, an iris sensor, or an illuminance sensor) may be implemented as embedded in the display device 460 (e.g., a display).

The processor 420 may execute, for example, software (e.g., a program 440) to control at least one other component (e.g., a hardware or software component) of the electronic device 401 coupled with the processor 420, and may perform various data processing or computation. According to one embodiment, as at least part of the data processing or computation, the processor 420 may load a command or data received from another component (e.g., the sensor module 476 or the communication module 490) in volatile memory 432, process the command or the data stored in the volatile memory 432, and store resulting data in non-volatile memory 434. According to an embodiment, the processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally, or alternatively, the auxiliary processor 423 may be adapted to consume less power than the main processor 421, or to be specific to a specified function. The auxiliary processor 423 may be implemented as separate from, or as part of the main processor 421.

The auxiliary processor 423 may control at least some of functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). According to an embodiment, the auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software(e.g., the program 440) and input data or output data for a command related thereto. The memory 430 may include the volatile memory 432 or the non-volatile memory 434.

The program 440 may be stored in the memory 430 as software, and may include, for example, an operating system (OS) 442, middleware 444, or an application 446.

The input device 450 may receive a command or data to be used by other component (e.g., the processor 420) of the electronic device 401, from the outside (e.g., a user) of the electronic device 401. The input device 450 may include, for example, a microphone, a mouse, a keyboard, or a digital pen a stylus pen).

The sound output device 455 may output sound signals to the outside of the electronic device 401. The sound output device 455 may include, for example, a speaker or a receiver. The speaker may be used for general purposes, such as playing multimedia or playing record, and the receiver may be used for incoming calls. According to an embodiment, the receiver may be implemented as separate from, or as part of the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. According to an embodiment, the display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. According to an embodiment, the audio module 470 may obtain the sound via the input device 450, or output the sound via the sound output device 455 or a headphone of an external electronic device (e.g., an electronic device 402) directly (e.g., wiredly) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. According to an embodiment, the sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device (e.g., the electronic device 402) directly (e.g., wiredly) or wirelessly. According to an embodiment, the interface 477 may include, for example, a high definition multimedia interface (HDMI), a universal serial bus (USB) interface, a secure digital (SD) card interface, or an audio interface.

A connecting terminal 478 may include a connector via which the electronic device 401 may be physically connected with the external electronic device (e.g., the electronic device 402). According to an embodiment, the connecting terminal 478 may include, for example, a HDMI connector, a USB connector, a SD card connector, or an audio connector (e.g., a headphone connector).

The haptic module 479 may convert an electrical signal into a mechanical stimulus (e.g., a vibration or a movement) or electrical stimulus which may be recognized by a user via his tactile sensation or kinesthetic sensation. According to an embodiment, the haptic module 479 may include, for example, a motor, a piezoelectric element, or an electric stimulator.

The camera module 480 may capture a still image or moving images. According to an embodiment, the camera module 480 may include one or more lenses, image sensors, image signal processors, or flashes.

The power management module 488 may manage power supplied to the electronic device 401. According to one embodiment, the power management module 488 may be implemented as at least part of, for example, a power management integrated circuit (PMIC).

The battery 489 may supply power to at least one component of the electronic device 401. According to an embodiment, the battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the application processor (AP)) and supports a direct (e.g., wired) communication or a wireless communication. According to an embodiment, the communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as Bluetooth™, wireless-fidelity (Wi-Fi) direct, or infrared data association (IrDA)) or the second network 499 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. According to an embodiment, the antenna module 497 may include an antenna including a radiating element composed of a conductive material or a conductive pattern formed in or on a substrate (e.g., PCB). According to an embodiment, the antenna module 497 may include a plurality of antennas. In such a case, at least one antenna appropriate for a communication scheme used in the communication network, such as the first network 498 or the second network 499, may be selected, for example, by the communication module 490 (e.g., the wireless communication module 492) from the plurality of antennas. The signal or the power may then be transmitted or received between the communication module 490 and the external electronic device via the selected at least one antenna. According to an embodiment, another component (e.g., a radio frequency integrated circuit (RFIC)) other than the radiating element may be additionally formed as part of the antenna module 497.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 401 and the external electronic device 404 via the server 408 coupled with the second network 499. Each of the electronic devices 402 and 404 may be a device of a same type as, or a different type, from the electronic device 401. According to an embodiment, all or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 440) including one or more instructions that are stored in a storage medium (e.g., internal memory 436 or external memory 438) that is readable by a machine (e.g., the electronic device 401). For example, a processor (e.g., the processor 420) of the machine (e.g., the electronic device 401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively, or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

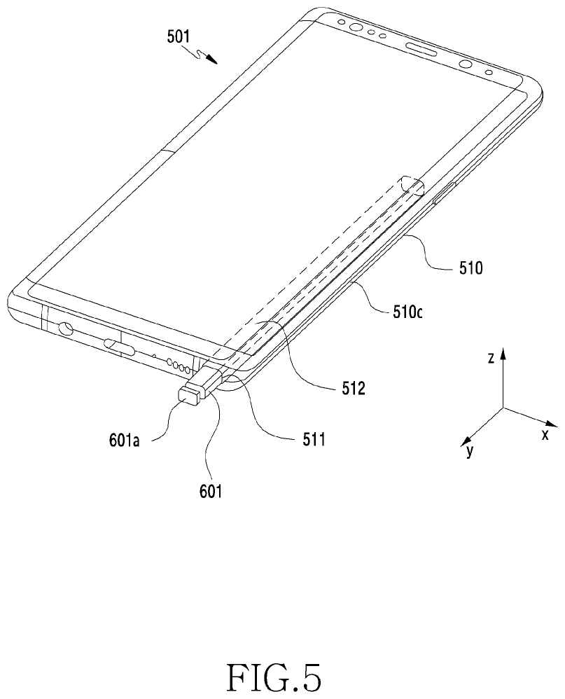

FIG. 5 illustrates a perspective view of an electronic device including a digital pen according to an embodiment.

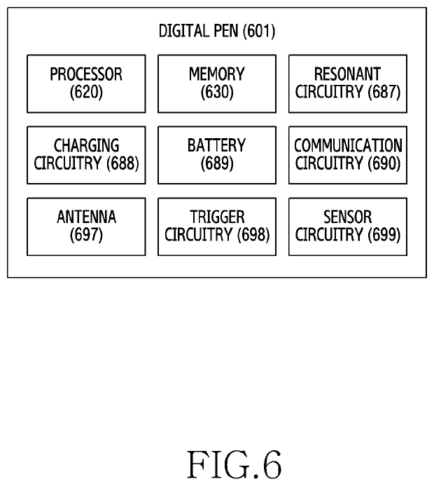

FIG. 6 illustrates a block diagram of a digital pen according to an embodiment.

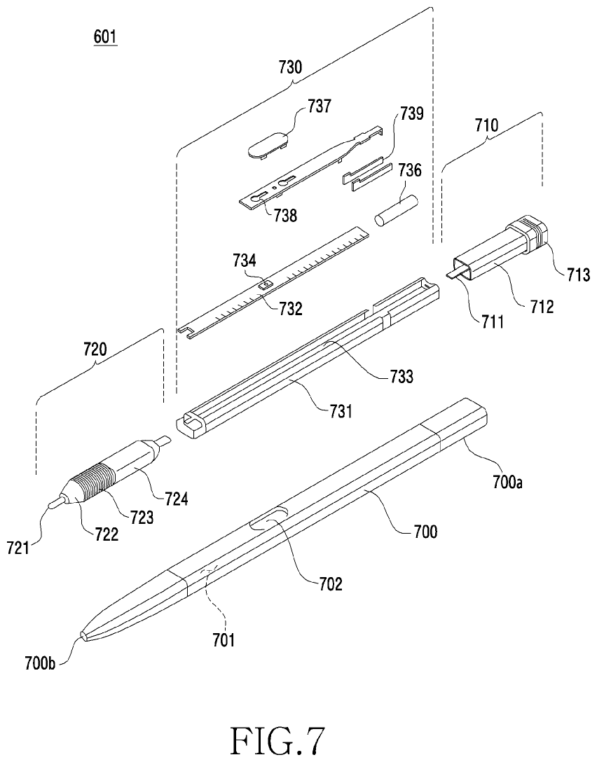

FIG. 7 illustrates an exploded view of a digital pen according to an embodiment.

Referring to FIG. 5, an electronic device 501 according to an embodiment may include the configuration of FIG. 4, and may include a structure for inserting a digital pen 601 (e.g., a stylus pen). The electronic device 501 may include a housing 510, and a hole 511 in part of the housing 510, for example, in part of a side surface 510c. The electronic device 501 may include a receiving space 512 connected to the hole 511, and the digital pen 601 may be inserted into the receiving space 512. The digital pen 601 may include a button 601a at one end, which is pressed to easily fetch the digital pen 601 from the receiving space 512 of the electronic device 501. If the button 601a is pressed, an opposing mechanism (e.g., at least one spring) associated with the button 601a may work to detach the digital pen 601 from the receiving space 512. In various embodiments, the components of the electronic device 501 may reside in the housing 510, and some components (e.g., the input device 450, the sound output device 455) may be exposed through a part of the housing 510. In various embodiments, a microphone of the input device 450, which is exposed through a part of the housing 510, may acquire an audio signal.

Referring to FIG. 6, the digital pen 601 according to an embodiment may include a processor 620, a memory 630, resonant circuitry 687, charging circuitry 688, a battery 689, communication circuitry 690, an antenna 697, trigger circuitry 698, and/or sensor circuitry 699. In some embodiments, the processor 620, at least part of the resonant circuitry 687, and/or at least part of the communication circuitry 690 of the digital pen 601 may be constructed on a printed circuitry board or as a chip. The processor 620, the resonant circuitry 687, and/or the communication circuitry 690 may be electrically coupled with the memory 630, the charging circuitry 688, the battery 689, the antenna 697, the trigger circuitry 698, and/or the sensor circuitry 699. The digital pen 601 according to an embodiment may include only a resonant circuitry and a button.

The processor 620 may include a generic processor configured to execute a customized hardware module or software (e.g., an application program). The processor 620 may include a hardware component (function) or a software component (program) including at least one of various sensors of the digital pen 601, a data measuring module, an input/output interface, a module which manages a state or an environment of the digital pen 601, or a communication module. The processor 620 may include a combination of one or more of, for example, hardware, software, or firmware. According to an embodiment, the processor 620 may receive a proximity signal corresponding to an electromagnetic signal generated from a digitizer of the display device 460 of the electronic device 401, through the resonant circuitry 687. If identifying the proximity signal, the processor 620 may control the resonant circuitry 687 to transmit an electro-magnetic resonant (EMR) input signal to the electronic device 401.

The memory 630 may store operation information of the digital pen 601. For example, the information may include communication information for the electronic device 401 and frequency information for the input of the digital pen 601.

The resonant circuitry 687 may include at least one of a coil, an inductor, or a capacitor. The resonant circuitry 687 may be used for the digital pen 601 to generate a signal including a resonant frequency. For example, to generate the signal, the digital pen 601 may use at least one of an EMR scheme, an active electrostatic (AES) scheme, or an electrically coupled resonant (ECR) scheme. If the digital pen 601 transmits a signal using the EMR scheme, the digital pen 601 may generate the signal including the resonant frequency, based on an electromagnetic field generated from an inductive panel of the electronic device 401. If the digital pen 601 transmits a signal using the AES scheme, the digital pen 601 may generate the signal using capacity coupling with the electronic device 401. If the digital pen 601 transmits a signal using the ECR scheme, the digital pen 601 may generate the signal including the resonant frequency, based on an electric field generated from a capacitive device of the electronic device 401. According to an embodiment, the resonant circuitry 687 may be used to change an intensity or a frequency of the electromagnetic field, according to a user's manipulation. For example, the resonant circuitry 687 may provide a frequency for recognizing a hovering input, a drawing input, a button input, or an erasing input.

If the charging circuitry 688 is connected to the resonant circuitry 687 based on switching circuitry, the charging circuitry 688 may rectify the resonant signal generated at the resonant circuitry 687 as a direct current signal and provide the direct current signal to the battery 689. According to an embodiment, using a voltage level of the direct current signal detected at the charging circuitry 688, the digital pen 601 may identify whether the digital pen 601 is inserted to the electronic device 501.

The battery 689 may be configured to store power required to operate the digital pen 601. The battery 689 may include, for example, a lithium-ion battery or a capacitor. The battery 689 may be rechargeable or exchangeable. According to an embodiment, the battery 689 may be charged using the power (e.g., the direct current signal (direct current power)) provided from the charging circuitry 688.

The communication circuitry 690 may be configured to enable wireless communication between the digital pen 601 and the communication module 490 of the electronic device 401. For example, the communication circuitry 690 may transmit state information and input information of the digital pen 601 to the electronic device 401 using short-range communication. For example, the communication circuitry 690 may transmit orientation information (e.g., motion sensor data) of the digital pen 601 acquired using the sensor circuitry 699, voice information inputted through the microphone, or remaining battery level information of the battery 689, to the electronic device 401. For example, the short-range communication may include at least one of Bluetooth, Bluetooth low energy (BLE) or wireless LAN.

The antenna 697 may be used to transmit or receive the signal or the power to or from outside (e.g., the electronic device 401). For example, the digital pen 601 may include a plurality of the antennas 697, and select at least one antenna 697 adequate for the communication type. Via the at least one antenna 697 selected, the communication circuitry 690 may exchange the signal or the power with an external electronic device.

The trigger circuitry 698 may include at least one button. According to an embodiment, the processor 620 may identify a button input method (e.g., touch or press) or type (e.g., an EMR button or a BLE button) of the digital pen 601. According to an embodiment, the digital pen 601 may transmit a signal based on the button input of the trigger circuitry 698, to the electronic device 401.

The sensor circuitry 699 may generate an electric signal or a data value corresponding to an internal operation state or an external environment state of the digital pen 601. For example, the sensor circuitry 699 may include at least one of a motion sensor (e.g., a gesture sensor, an acceleration sensor, a gyro sensor, a proximity sensor, or a combination thereof), a remaining battery level detecting sensor, a pressure sensor, an illuminance sensor, a temperature sensor, a geomagnetic sensor, or a biometric sensor. According to an embodiment, the digital pen 601 may transmit a signal detected by the sensor of the sensor circuitry 699, to the electronic device 401.

Referring to FIG. 7, the digital pen 601 may include a pen housing 700 forms an exterior of the digital pen 601, and an inner assembly in the pen housing 700. The inner assembly may include all of the various components mounted in the digital pen 601, and may be inserted into the pen housing 700 through one assembly operation.

The pen housing 700 may be in a shape extending long between a first end 700a and a second end 700b, and may include a receiving space 701 therein. A cross section of the pen housing 700 may be oval including a major axis and a minor axis, and the pen housing 700 may be formed in a cylindrical shape. A cross section of the receiving space 512 of the electronic device 501 may be also formed in an oval shape corresponding to the shape of the pen housing 700. The pen housing 700 may include a synthetic resin (e.g., plastic) and/or a metallic material (e.g., aluminum). According to an embodiment, the second end 700b of the pen housing 700 may be formed of a synthetic resin material.

The inner assembly may be in a shape extending long corresponding to the shape of the pen housing 700. The inner assembly may be divided into three configurations in a longitudinal direction. For example, the inner assembly may include an ejection member 710 disposed at a position corresponding to the first end 700a of the pen housing 700, a coil unit 720 disposed at a position corresponding to the second end 700b of the pen housing 700, a circuit board unit 730 disposed at a position corresponding to a body of the pen housing 700.

The ejection member 710 may include a construction for ejecting the digital pen 601 from the receiving space 512 of the electronic device 501. According to an embodiment, the ejection member 710 may include a shaft 711, an ejection body 712 disposed around the shaft 711 and forming an exterior of the ejection member 710, and a button unit 713. If the inner assembly is completely inserted into the pen housing 700, a portion including the shaft 711 and the ejection body 712 may be surrounded by the first end 700a of the pen housing 700 and the button unit 713 (e.g., 501a of FIG. 5) may be exposed outside the first end 700a. A plurality of components not shown, for example, cam members or elastic members may be disposed in the ejection member 710 to build a push-pull structure. In an embodiment, the button unit 713 may be coupled substantially with the shaft 711 to perform a linear reciprocating motion with respect to the ejection member 710. According to various embodiments, the button unit 713 may include a button of a latching structure allowing a user to eject the digital pen 601 using his/her nail. According to an embodiment, the digital pen 601 may include a sensor for detecting the linear reciprocating motion of the shaft 711, and thus provide a different input method.

The coil unit 720 may include a pen tip 721 exposed outside the second end 700b if the inner assembly is completely inserted to the pen housing 700, a packing ring 722, a coil 723 wound multiple times, and/or a pen pressure detector 724 for acquiring a pressure change according to pressing the pen tip 721. The packing ring 722 may include epoxy, rubber, urethane, or silicon. The packing ring 722 may be disposed for the sake of protection against water and dust, to protect the coil unit 720 and the circuit board unit 730 from water or dust. According to an embodiment, the coil 723 may generate a resonant frequency in a set frequency band (e.g., 500 kHz), and may control its resonant frequency within a specific range in conjunction with at least one element (e.g., a capacitor).

The circuit board unit 730 may include a printed circuit board 732, a base 731 surrounding at least one side of the printed circuit board 732, and an antenna. According to an embodiment, a board receiving unit 733 for receiving the printed circuit board 732 is formed on the base 731, and the printed circuit board 732 may be secured in the board receiving unit 733. According to an embodiment, the board receiving unit 733 may include an upper surface and a lower surface, the upper surface may include a variable capacitor or a switch 734 connected to the coil 723, and the lower surface may include charging circuitry, a battery, or communication circuitry. The battery may include an electric double layered capacitor (EDLC). The charging circuitry is disposed between the coil 723 and the battery, and may include a voltage detector circuitry and a rectifier.

The antenna may include an antenna structure 739 of FIG. 7 and/or an antenna embedded in the printed circuit board 732. According to various embodiments, the switch 734 may be disposed on the printed circuit board 732. A side button 737 of the digital pen 601 may be used to press the switch 734 and exposed to the outside through a side opening 702 of the digital pen 601. If the side button 737 is supported by a support member 738 and no external force is exerted to the side button 737, the support member 738 may provide an elastic restoring force to restore or maintain the side button 737 at a specific position.

The circuit board unit 730 may include other packing ring such as an O-ring. For example, the O-ring formed with an elastic material may be disposed at both ends of the base 731, to build a sealing structure between the base 731 and the pen housing 700. In some embodiment, the support member 738 may build the sealing structure by closely attaching, in part, to are inner wall of the pen housing 700 around the side opening 702. For example, the circuit board unit 730 may also build a waterproof and dustproof structure similar to the packing ring 722 of the coil unit 720.

The digital pen 601 may include a battery receiving unit for receiving a battery 736, on the base 731. The battery 736 mounted in the battery receiving unit (not shown) may include, for example, a cylinder-type battery.

The digital pen 601 may include a microphone (not shown). The microphone may be directly connected to the printed circuit board 732, to a separate flexible printed circuit board (FPCB) (not shown) coupled with the printed circuit board 732. According to various embodiments, the microphone may be disposed in parallel with the side button 737 in the longitudinal direction of the digital pen 601.

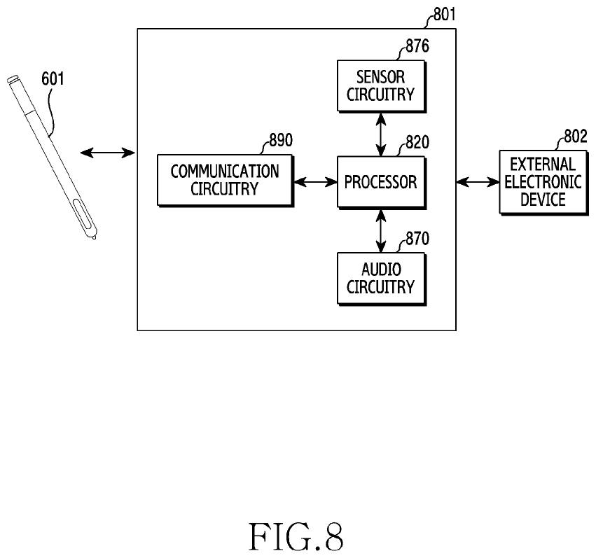

FIG. 8 illustrates a block diagram of an electronic device 801, a digital pen 601, and an external electronic device 802 according to various embodiments. In various embodiments, the functional configuration of the electronic device 801 of FIG. 8 may include the functional configuration of the user terminal 100 of FIG. 1, the functional configuration of the electronic device 401 of FIG. 4, or the functional configuration of the electronic device 501 of FIG. 5. In various embodiments, the functional configuration of the digital pen 601 of FIG. 8 may include the functional configuration of the digital pen 601 of FIG. 6 or FIG. 7. In various embodiments, the external electronic device 802 of FIG. 8 may be the electronic device 402 of FIG. 4, the electronic device 404 of FIG. 4, or a combination thereof.

Referring to FIG. 8, the electronic device 801 may include a processor 820, audio circuitry 870, sensor circuitry 876, communication circuitry 890, or a combination thereof.

In various embodiments, the functional configuration of the processor 820 may include the functional configuration of the processor 160 of FIG. 1 or the functional configuration of the processor 420 of FIG. 4. In various embodiments, the functional configuration of the audio circuitry 870 may include the functional configuration of the microphone 120 of FIG. 1 or the functional configuration of the audio module 470 of FIG. 4. In various embodiments, the functional configuration of the sensor circuitry 876 may include the functional configuration of the sensor module 476 of FIG. 4. In various embodiments, the functional configuration of the communication circuitry 890 may include the functional configuration of the communication interface 110 of FIG. 1 or the functional configuration of the communication module 490 of FIG. 4.

In various embodiments, the processor 820 may activate a voice recognition function in response to receiving a designated signal from the digital pen 601. In various embodiments, the designated signal of the digital pen 601 may include a signal generated according to user's depressing an input button (e.g., the trigger circuitry 698), a signal generated by sensor circuitry (e.g., the sensor circuitry 699) in response to an internal operation state or an external environment state of the digital pen 601, a signal acquired by communication circuitry (e.g., the communication circuitry 690) from other electronic device (e.g., the electronic device 402), or a combination thereof. In various embodiments, the designated signal of the digital pen 601 may be set in response to an application currently running on the processor 820. In various embodiments, in a first application of a plurality of applications, the designated signal of the digital pen 601 may be set to the signal generated by the user's depressing the input button (e.g., the trigger circuitry 698). In various embodiments, in a second application of the applications, the designated signal of the digital pen 601 may be set to the signal generated by the sensor circuitry (e.g., the sensor circuitry 699) in response to the internal operation state of the digital pen 601.

In various embodiments, the processor 820 may activate the audio circuitry 870 to acquire a voice signal in response to receiving the designated signal of the currently running application from the digital pen 601.

In various embodiments, the processor 820 may process the voice signal obtained from the audio circuitry 870, by executing at least one of a client module (e.g., the client module 151 of FIG. 1) or an SDK (e.g., the SDK 153 of FIG. 1) in response to the voice signal obtained from the audio circuitry 870.

In various embodiments, the processor 820 may execute a first function corresponding to a result of processing the voice signal obtained from the audio circuitry 870 by executing at least one of the client module (e.g., the client module 151 of FIG. 1) or the SDK (e.g., the SDK 153 of FIG. 1), among functions supportable by the currently running application. The operations for selecting the first function indicated by the processing result of the voice signal from the supportable functions of the current application and executing the first functions are now described by referring to the drawings.

In various embodiments, the processor 820 may determine a parameter of the first function indicated by the processing result of the voice signal, based on a signal received from the digital pen 601 after the designated signal is received. In various embodiments, the signal received from the digital pen 601 after the designated signal is received may include the signal generated according to the user's depressing the input button (e.g., the trigger circuitry 698), the signal generated by the sensor circuitry (e.g., the sensor circuitry 699) in response to the internal operation state or the external environment state of the digital pen 601, the signal acquired by the communication circuitry (e.g., the communication circuitry 690) from other electronic device (e.g., the electronic device 402), the audio signal acquired through the audio circuitry 870, the signal generated in response to the internal operation state or the external environment state of the electronic device 801 acquired by the sensor circuitry 876, or a combination thereof.

In various embodiments, based on the number of the signals generated according to the user's depressing the input button (e.g., the trigger circuitry 698), the processor 820 may determine the parameter of the first function indicated by the processing result of the voice signal. In various embodiments, the signal generated according to the user's depressing the input button (e.g., the trigger circuitry 698) may be acquired from a time at which the designated signal is received from the digital pen 601. In various embodiments, the signal generated according to the user's depressing the input button (e.g., the trigger circuitry 698) may be acquired until the voice signal input is completed. In various embodiments, the signal generated according to the user's depressing the input button (e.g., the trigger circuitry 698) may be acquired until the first function indicated by the voice signal processing result is selected.

In various embodiments, if the currently running application is an external electronic device control application and the first function indicated by the processing result of the voice signal is a volume control function, the processor 820 may determine the parameter (e.g., a volume value) of the first function for the volume control, based on the number of the signals generated according to the user's depressing the input button (e.g., the trigger circuitry 698).

In various embodiments, based at least in part on a motion signal, the processor 820 may determine the parameter of the first function indicated by the processing result of the voice signal. In various embodiments, the motion signal may be acquired from the time at which the designated signal is received from the digital pen 601. In various embodiments, the motion signal may be acquired until the voice signal input is finished. In various embodiments, the motion signal may be acquired until the first function indicated by the voice signal processing result is selected. In various embodiments, the motion signal may be a motion signal of the sensor circuitry 876, a motion signal of the sensor circuitry (e.g., the sensor circuitry 699 of FIG. 6) of the digital pen 601, a motion signal of the external electronic device 802, or a combination thereof.

In various embodiments, if the currently running application is the external electronic device control application and the first function indicated by the processing result of the voice signal is the volume control function, the processor 820 may determine the parameter the volume value) of the first function for the volume control, based at least in part on the motion signal.

In various embodiments, based on the signal acquired by the communication circuitry (e.g., the communication circuitry 690) from other electronic device (e.g., the electronic device 402), the processor 820 may determine the parameter of the first function indicated by the processing result of the voice signal. In various embodiments, the signal acquired by the communication circuitry (e.g., the communication circuitry 690) from the other electronic device (e.g., the electronic device 402) may be acquired from the time at which the designated signal is received from the digital pen 601. In various embodiments, the signal acquired by the communication circuitry (e.g., the communication circuitry 690) from the other electronic device (e.g., the electronic device 402) may be acquired until the voice signal input is finished. In various embodiments, the signal acquired by the communication circuitry (e.g., the communication circuitry 690) from the other electronic device (e.g., the electronic device 402) may be acquired until the first function indicated by the voice signal processing result is selected.

In various embodiments, if the currently running application is the external electronic device control application and the first function indicated by the processing result of the voice signal is the volume control function, the processor 820 may determine the para the volume value) of the first function for the volume control, based on the signal acquired by the communication circuitry (e.g., the communication circuitry 690) from the other electronic device (e.g., the electronic device 402).

In various embodiments, based on control of the processor 820, the audio circuitry 870 may be activated to convert a sound to a voice signal. In various embodiments, the voice signal converted at the audio circuitry 870 may be inputted to at least one of the client module (e.g., the client module 151 of FIG. 1) or the SDK (e.g., the SDK 153 of FIG. 1) which is executed by the processor 820, and used to identify a function indicated by the voice signal among the supportable functions of the current application.

In various embodiments, based on the control of the processor 820, the sensor circuitry 876 may detect the operation state (e.g., a displacement or an acceleration) of the electronic device 801 or the external environment state (e.g., a user state or an accessory attached or detached), and generate an electric signal or a data value corresponding to the detected state. In various embodiments, the sensor circuitry 876 may include, for example, a gesture sensor, a gyro sensor, an acceleration sensor, a grip sensor, a proximity sensor, or a combination thereof.

In various embodiments, based on the control of the processor 820, the communication circuitry 890 may be configured to receive an input from the digital pen 601. In various embodiments, based on the control of the processor 820, the communication circuitry 890 may be configured to receive an input from the external electronic device 802, or to transmit an input for the external electronic device 802.

In various embodiments, the digital pen 601 may cause an input at the electronic device 801 using a signal generated by a resonant circuitry (e.g., the resonant circuitry 687 of FIG. 6). In various embodiments, the digital pen 601, which causes the input at the electronic device 801, may be referred to as an input tool, an input means, or an input device. In various embodiments, the digital pen 601, which is in the pen shape, may be referred to as a stylus.

In various embodiments, the digital pen 601 may transmit signals acquired by the digital pen 601 to the electronic device 801, via the communication circuitry (e.g., the communication circuitry 690). In various embodiments, the signals acquired by the digital pen 601 may include the signal generated according to the user's depressing the input button (e.g., the trigger circuitry 698), the signal generated by the sensor circuitry (e.g., the sensor circuitry 699) in response to the internal ration state or the external environment state of the digital pen 601, the signal acquired by the communication circuitry (e.g., the communication circuitry 690) from the other electronic device, or a combination thereof.

In various embodiments, the signal acquired at the communication circuitry (e.g., the communication circuitry 690) of the digital pen 601 from the other electronic device may include a signal acquired at the communication circuitry (e.g., the communication circuitry 690) by reading a tag (e.g., an RFID tag) attached to other electronic device, or a signal acquired at the communication circuitry (e.g., the communication circuitry 690) by communicating with communication circuitry (e.g., BLE) of other electronic device.

In various embodiments, the external electronic device 802 may include various devices fur communicating with the electronic device 801. In various embodiments, the external electronic device 802 may include a portable communication device a smartphone), a computer device, a portable multimedia device, a portable medical device, a camera, a wearable device, home appliances, an unmanned vehicle (e.g., an unmanned aerial vehicle (UAV), an unmanned ground vehicle (UGV), an unmanned surface vehicle (USV), an unmanned underwater vehicle (UUV), or a combination thereof), or their combination.

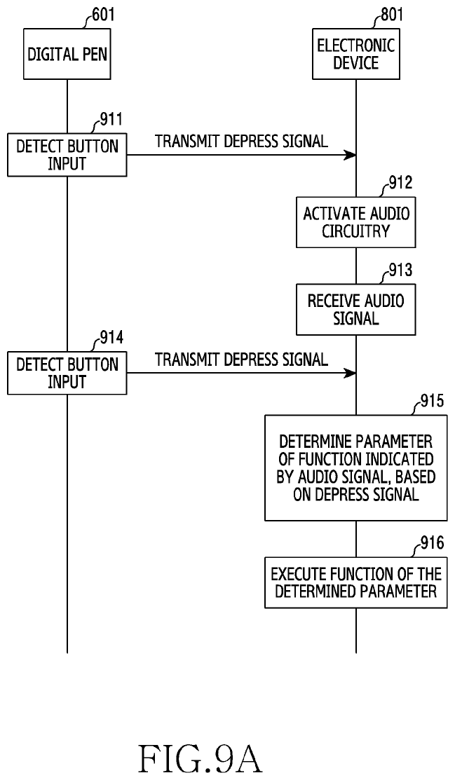

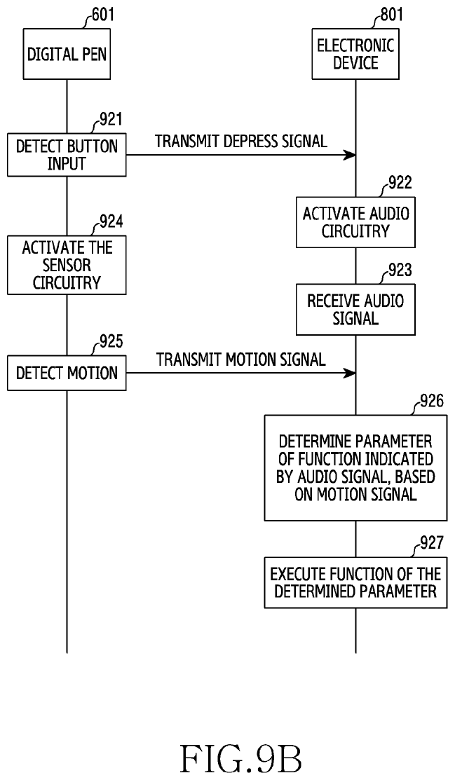

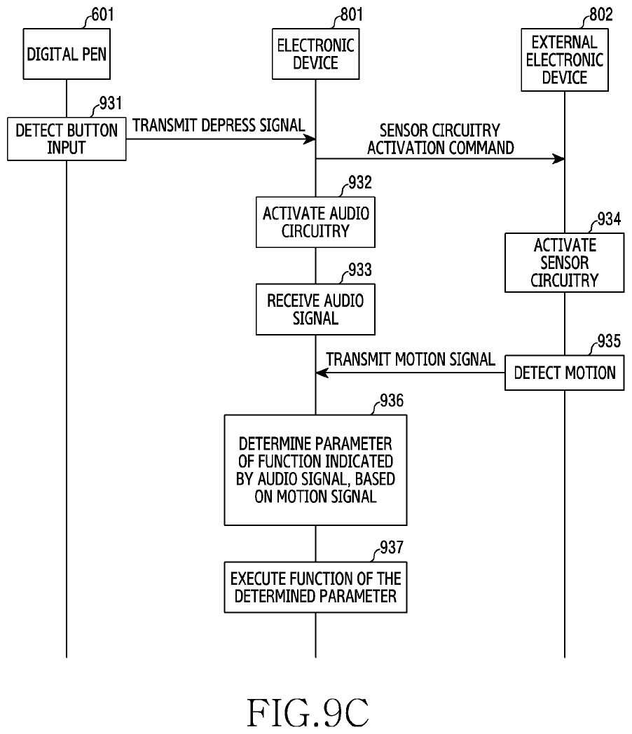

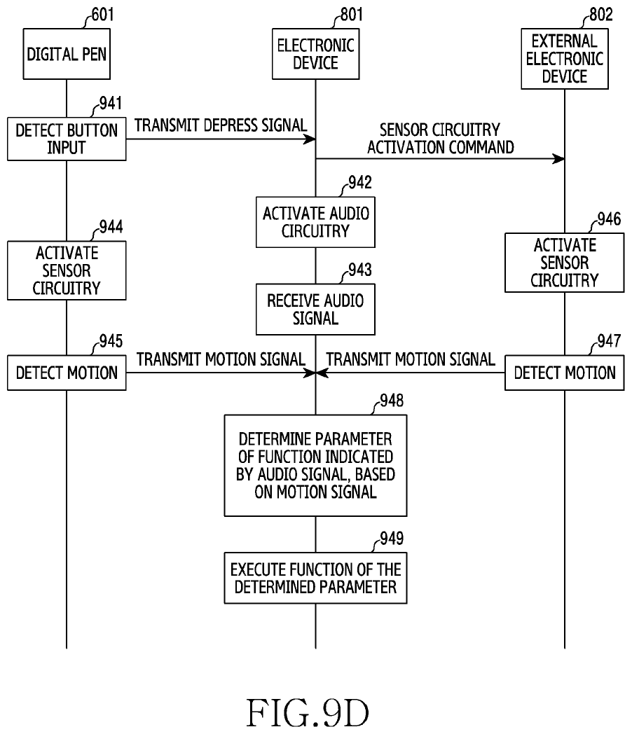

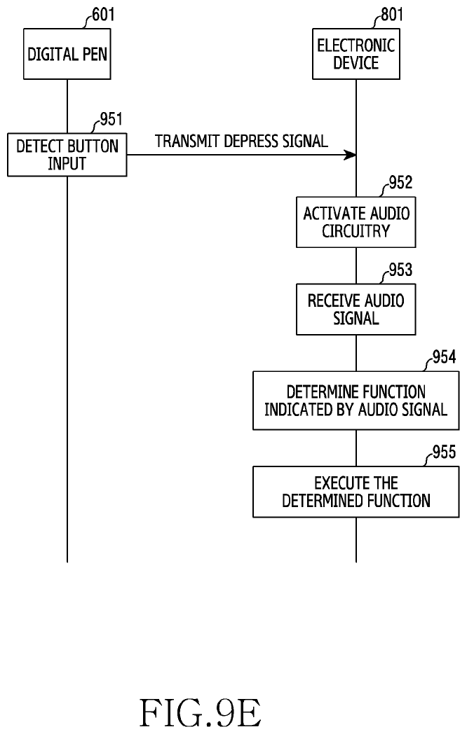

FIGS. 9A through 9E illustrate an example of operations of an electronic device 801 according to various embodiments. In various embodiments, the functional configuration of the electronic device 801 of FIGS. 9A through 9E may include the functional configuration of the user terminal 100 of FIG. 1, the functional configuration of the electronic device 401 of FIG. 4, the functional configuration of the electronic device 501 of FIG. 5, or the functional configuration of the electronic device 801 of FIG. 8. In various embodiments, the functional configuration of the digital pen 601 of FIGS. 9A through 9E may include the functional configuration of the digital pen 601 of FIG. 6, FIG. 7 or FIG. 8. In various embodiments, the external electronic device 802 of FIGS. 9A through 9E may be the electronic device 402 of FIG. 4, the electronic device 404 of FIG. 4, or the external electronic device 802 of FIG. 8

The functional configuration of the electronic device 801 of FIGS. 9A through 9E is explained by referring to the functional configuration of the electronic device 801 of FIG. 8, and the functional configuration of the digital pen 601 of FIGS. 9A through 9E is explained by referring to the functional configuration of the digital pen 601 of FIG. 6.

Referring to 9A, in operation 911, the processor 620 of the digital pen 601 may detect a button input. In various embodiments, the button input may be user's depressing an input button (e.g., the trigger circuitry 698) of the digital pen 601.

In various embodiments, in response to detecting the button input in operation 911, the processor 620 of the digital pen 601 may generate a depress button corresponding to the button input. In various embodiments, the depress button may be generated according to the user's depressing the input button (e.g., the trigger circuitry 698) of the digital pen 601. In various embodiments, the processor 620 of the digital pen 601 may transmit the depress button to the electronic device 801 via the communication circuitry 690. In various embodiments, the depress signal of operation 911 may be estimated as a first radio signal of the digital pen 601.

Referring to FIG. 9A, in operation 912, the processor 620 of the digital pen 601 may activate the audio circuitry 870, in response to receiving the depress signal. In various embodiments, the processor 620 of the digital pen 601 may identify the depress signal as a designated signal of a currently running application. In various embodiments, the processor 820 of the electronic device 801 may activate the audio circuitry 870, in response to identifying the depress signal as the designated signal of the currently running application.

In FIG. 9A, while the depress signal of operation 911 is the designated signal of the currently running application in operation 912, the designated signal of the currently running application may be the signal generated by the sensor circuitry (e.g., the sensor circuitry 699) in response to the internal operation state or the external environment state of the digital pen 601, or the signal acquired by the communication circuitry (e.g., the communication circuitry 690) from other electronic device, besides the depress signal. Hence, even if receiving other signal than the depress signal from the digital pen 601, the processor 820 of the electronic device 801 may activate the audio circuitry 870, by identifying whether the other signal than the depress signal received from the digital pen 601 is the designated signal of the currently running application.

Referring to FIG. 9A, in operation 913, the processor 820 of the electronic device 801 may receive an audio signal through the activated audio circuitry 870. In various embodiments, in response to receiving the audio signal in operation 913, the processor 820 of the electronic device 801 may process the audio signal acquired through the activated audio circuitry 870, by executing at least one of the client module (e.g., the client module 151 of FIG. 1) or the SDK (e.g., the SDK 153 of FIG. 1). In various embodiments, the processor 820 of the electronic device 801 may identify a function indicated by a result of processing the signal acquired through the audio circuitry 870 by executing at least one of the client module (e.g., the client module 151 of FIG. 1) or the SDK (e.g., the SDK 153 of FIG. 1), among functions supported by the currently running application.

Referring to FIG. 9A, in operation 914, the processor 620 of the digital pen 601 may detect a button input. In various embodiments, in response to detecting the button input in operation 911, the processor 620 of the digital pen 601 may generate a depress signal corresponding to the button input. In various embodiments, the processor 620 of the digital pen 601 may transmit the depress signal to the electronic device 801 via the communication circuitry 690.

In various embodiments, detecting the button input and transmitting the depress signal of operation 914 may be repeated. In various embodiments, detecting the button input and transmitting the depress signal of operation 914 may be perform from the time at which the processor 620 of the digital pen 601 detects the button input in operation 911. In various embodiments, detecting the button input and transmitting the depress signal of operation 914 be perform until the reception of the audio signal is completed in operation 913. In various embodiments, detecting the button input and transmitting the depress signal of operation 914 may be perform until the function indicated by the processing result of the received audio signal is selected after the reception of the audio signal is finished in operation 913.

Referring to FIG. 9A, in operation 915, the processor 820 of the electronic device 801 may determine a parameter of the function indicated by the audio signal of operation 913, based on the depress signal of the button input of operation 914. In various embodiments, the processor 820 of the electronic device 801 may determine the parameter of the function indicated by the audio signal of operation 913, based on the number of the repetitions of detecting the button input and transmitting the depress signal of operation 914.

In various embodiments, in operation 915, if the currently running application is an external electronic device control application and the function indicated by the processing result of the audio signal is a volume control function, the processor 820 of the electronic device 801 may determine the parameter (e.g., a volume value) of the function for the volume control, based on the number of the repetitions of detecting the button input and transmitting the depress signal of operation 914. In various embodiments, if detecting the button input and transmitting the depress signal of operation 914 are repeated three times, the processor 820 of the electronic device 801 may determine the parameter (e.g., the volume value) of the volume control function indicated by the audio signal processing result among the functions supported by the currently running application, to a volume value increased (or decreased) by three from a current volume value. In various embodiments, the function indicated by the audio signal processing result may include functions including parameters controlled with one single button input such as external electronic device ON-OFF control, temperature control, television channel control, or radio channel control, besides the volume control.

Referring to FIG. 9A, in operation 915, if no application is currently running (e.g., applications are running on background, a home screen is displayed) and the function indicated by the processing result of the audio signal is a name (e.g., television) and the volume control of the external electronic device to control, the processor 820 of the electronic device 801 may determine the parameter (e.g., the volume value) of the volume control function of the external electronic device to control, based on the number of the repetitions of detecting the button input and transmitting the depress signal of operation 914.

Referring to FIG. 9A, in operation 916, the processor 820 of the electronic device 801 may execute the function of the determined parameter. In various embodiments, by executing the function of the determined parameter in operation 915, the processor 820 of the electronic device 801 may control the currently running application control the external electronic device which is the control target of the currently running application, in operation 916.

In various embodiments, if the parameter (e.g., the volume value) of the volume control function indicated by the audio signal processing result among the functions supported by the currently running application is determined to the volume value increased by three from the current volume value in operation 915, the processor 820 of the electronic device 801 may control the volume of the external electronic device which is the control target of the currently running application, by executing the function of the determined parameter with respect to the currently running application in operation 916.

In various embodiments, in operation 916, if the currently running application is a voice call application, the processor 820 of the electronic device 801 may control the volume of a current voice call, by executing the function of the determined parameter with respect to the currently running application.

Referring to FIG. 9B, operation 921 may correspond to operation 911 of FIG. 9A, operation 922 may correspond to operation 912 of FIG. 9A, operation 923 may correspond to operation 913 of FIG. 9A, operation 926 may correspond to operation 915 of FIG. 9A, and operation 927 may correspond to operation 916 of FIG. 9A. Operations corresponding to operations 911 through 916 of FIG. 9A, among operations 921 through 927 of FIG. 9B, are described in brief.

Referring to FIG. 9B, in operation 921, the processor 620 of the digital pen 601 may detect a button input. In various embodiments, the processor 620 of the digital pen 601 may transmit a depress button generated in response to detecting the button input, to the electronic device 801 in operation 921.

Referring to FIG. 9B, in operation 922, the processor 820 of the electronic device 801 may activate the audio circuitry 870, in response to receiving the depress signal. In various embodiments, the processor 820 of the electronic device 801 may activate the audio circuitry 870, in response to identifying the depress signal as the designated signal of the currently running application.

Referring to FIG. 9B, in operation 923, the processor 820 of the electronic device 801 may receive an audio signal through the activated audio circuitry 870. In various embodiments, the processor 820 of the electronic device 801 may identify a function indicated by a result of processing the signal acquired through the activated audio circuitry 870 by executing at least one of the client module (e.g., the client module 151 of FIG. 1) or the SDK (e.g., the SDK 153 of FIG. 1), among functions supported by the currently running application.

Referring to FIG. 9B, in operation 924, the processor 620 of the digital pen 601 may activate the sensor circuitry 699. In various embodiments, the processor 620 of the digital pen 601 may activate the sensor circuitry 699, by activating motion sensor circuitry (e.g., a gesture sensor, a gyro sensor, an acceleration sensor, a grip sensor, a proximity sensor, or a combination thereof).

Referring to FIG. 9B, in operation 925, the processor 620 of the digital pen 601 may detect a motion of the digital pen 601 by activating the sensor circuitry 699. In various embodiments, in response to detecting the motion of the digital pen 601 in operation 925, the processor 620 of the digital pen 601 may generate a motion signal corresponding to the motion. In various embodiments, the processor 620 of the digital pen 601 may transmit the motion signal to the electronic device 801 through the communication circuitry 690. In various embodiments, the motion may be a motion of the digital pen 601 caused by the user. In various embodiments, the motion signal may include displacement information of the motion. In various embodiments, the displacement information may include a moving direction, a moving distance, an acceleration, or their combination, of the digital pen 601. In various embodiments, the motion signal of operation 925 may be estimated as a second radio signal of the digital pen 601.

In various embodiments, detecting the motion and transmitting the motion signal of operation 925 may be performed on a periodic basis. In various embodiments, detecting the motion and transmitting the motion signal of operation 925 may be perform from the time at which the processor 620 of the digital pen 601 detects the button input in operation 921. In various embodiments, detecting the motion and transmitting the motion signal of operation 925 may be perform until the reception of the audio signal is finished in operation 923. In various embodiments, detecting the motion and transmitting the motion signal of operation 925 may be perform until the function indicated by the processing result of the received audio signal is selected after the reception of the audio signal is completed in operation 923.

Referring to FIG. 9B, in operation 926, the processor 820 of the electronic device 801 may determine a parameter of the function indicated by the audio signal of operation 923, based on the motion signal of the detected motion of operation 925. In various embodiments, the processor 820 of the electronic device 801 may determine the parameter of the function indicated by the audio signal of operation 923, based on the displacement information of the motion signal of operation 925.

In various embodiments, in operation 926, if the currently running application is the external electronic device control application and the function indicated by the processing result of the audio signal is the volume control function, the processor 820 of the electronic device 801 may determine the parameter (e.g., a volume value) of the function for the volume control, based on the displacement information of the motion signal of operation 925. In various embodiments, if the volume control value indicated by the moving direction, the moving distance, the acceleration, or their combination based on the displacement information of the motion signal of operation 925 is 3, the processor 820 of the electronic device 801 may determine the parameter (e.g., the volume value) of the volume control function indicated by the audio signal processing result among the functions supported by the currently running application, to the volume value increased (or decreased) by three from the current volume value. In various embodiments, the function indicated by the audio signal processing result may include functions including parameters controlled with the motion signal, such as external electronic device ON-OFF control, temperature control, television channel control, or, radio channel control, besides the volume control.

Referring to FIG. 9B, in operation 927, the processor 820 of the electronic device 801 may execute the function of the determined parameter. In various embodiments, by executing the function of the determined parameter in operation 926, the processor 820 of the electronic device 801 may control the currently running application control the external electronic device which is the control target of the currently running application, in operation 927.

Referring to FIG. 9C, operation 931 may correspond to operation 921 of FIG. 9B, operation 932 may correspond to operation 922 of FIG. 9B, operation 933 may correspond to operation 923 of FIG. 9B, operation 934 may correspond to operation 924 of FIG. 9B, operation 935 may correspond to operation 925 of FIG. 9B, operation 936 may correspond to operation 926 of FIG. 9B, and operation 937 may correspond to operation 927 of FIG. 9B. Operations corresponding to operations 921 through 927 of FIG. 9B, among operations 931 through 937 of FIG. 9C are described in brief.

Referring to FIG. 9C, in operation 931, the processor 620 of the digital pen 601 may detect the button input. In various embodiments, the processor 620 of the digital pen 601 may transmit the depress button generated in response to detecting the button input, to the electronic device 801 in operation 931. In various embodiments, the processor 820 of the electronic device 801 may transmit a sensor circuitry activation command to the external electronic device 802, in response to identifying the depress signal as the designated signal of the currently running application.

Referring to FIG. 9C, in operation 932, the processor 820 of the electronic device 801 may activate the audio circuitry 870, in response to receiving the depress signal. In various embodiments, the processor 820 of the electronic device 801 may activate the audio circuitry 870, in response to identifying the depress signal as the designated signal of the currently running application.

Referring to FIG. 9C, in operation 933, the processor 820 of the electronic device 801 may receive an audio signal through the activated audio circuitry 870. In various embodiments, the processor 820 of the electronic device 801 may identify the function indicated by the result of processing the signal acquired through the audio circuitry 870 by executing at least one of the client module (e.g., the client module 151 of FIG. 1) or the SDK (e.g., the SDK 153 of FIG. 1), among the functions supported by the currently running application.

Referring to FIG. 9C, in operation 934, a processor (e.g., the processor 420 of FIG. 4) of the external electronic device 802 may activate sensor circuitry (e.g., the sensor module 476 of FIG. 4). In various embodiments, the processor (e.g., the processor 420 of FIG. 4) of the external electronic device 802 may activate the sensor circuitry (e.g., the sensor module 476 of FIG. 4), by activating motion sensor circuitry (e.g., a gesture sensor, a gyro sensor, an acceleration sensor, a grip sensor, a proximity sensor, or a combination thereof). In various embodiments, the processor (e.g., the processor 420 of FIG. 4) of the external electronic device 802 may activate the sensor circuitry (e.g., the sensor module 476 of FIG. 4), based on a sensor circuitry activation command transmitted in response to identifying the depress signal of operation 931 as the designated signal of the currently running application. In various embodiments, the external electronic device 802 may be a user's wearable device.

Referring to FIG. 9C, in operation 935, the processor (e.g., the processor 420 of FIG. 4) of the external electronic device 802 may detect a motion by activating the sensor circuitry the sensor module 476 of FIG. 4). In various embodiments, in response to detecting the motion in operation 935, the processor (e.g., the processor 420 of FIG. 4) of the external electronic device 802 may generate a motion signal corresponding to the motion. In various embodiments, the processor (e.g., the processor 420 of FIG. 4) of the external electronic device 802 may transmit the motion signal to the electronic device 801 through communication circuitry (e.g., the communication module 490 of FIG. 4). In various embodiments, the motion may be a motion of the external electronic device 802 caused by the user. In various embodiments, the motion signal may include displacement information of the motion. In various embodiments, the displacement information may include a moving direction, a moving distance, an acceleration, or their combination of the external electronic device 802. In various embodiments, the motion signal of operation 935 may be estimated as a third radio signal of the external electronic device 802.

In various embodiments, detecting the motion and transmitting the motion signal of operation 935 may be performed on a periodic basis. In various embodiments, detecting the motion and transmitting the motion signal of operation 935 may be perform from the time at which the processor 620 of the digital pen 601 detects the button input in operation 931. In various embodiments, detecting the motion and transmitting the motion signal of operation 935 may be perform until the reception of the audio signal is finished in operation 933. In various embodiments, detecting the motion and transmitting the motion signal of operation 935 may be perform until the function indicated by the processing result of the received audio signal is selected after the reception of the audio signal is finished in operation 933.

Referring to FIG. 9C, in operation 936, the processor 820 of the electronic device 801 may determine a parameter of the function indicated by the audio signal of operation 933, based on the motion signal of the detected motion of operation 935. In various embodiments, the processor 820 of the electronic device 801 may determine the parameter of the function indicated by the audio signal of operation 933, based on the displacement information of the motion signal of operation 935.

In various embodiments, in operation 936, if the currently running application is the external electronic device control application and the function indicated by the processing result of the audio signal is the volume control function, the processor 820 of the electronic device 801 may determine the parameter the volume value) of the function for the volume control, based on the displacement information of the motion signal of operation 935. In various embodiments, the control target of the external electronic device control application may be other external electronic device than the external electronic device 802.

Referring to FIG. 9C, in operation 937, the processor 820 of the electronic device 801 may execute the function of the determined parameter. In various embodiments, by executing the function of the determined parameter in operation 936, the processor 820 of the electronic device 801 may control the currently running application or control the external electronic device which is the control target of the currently running application, in operation 937.

Referring to FIG. 9D, operation 941 may correspond to operation 921 of FIG. 9B, operation 922 may correspond to operation 942 of FIG. 9B, operation 943 may correspond to operation 923 of FIG. 9B, operation 944 may correspond to operation 924 of FIG. 9B, operation 955 may correspond to operation 925 of FIG. 9B, operation 946 may correspond to operation 934 of FIG. 9C, operation 947 may correspond to operation 935 of FIG. 9C, operation 948 may correspond to operation 926 of FIG. 9B, and operation 949 may correspond to operation 927 of FIG. 9B.

Operations corresponding to operations 921 through 927 of FIG. 9B or operations 931 through 937 of FIG. 9C, among operations 941 through 949 of FIG. 9D, are described in brief.

Referring to FIG. 9D, in operation 941, the processor 620 of the digital pen 601 may detect the button input. In various embodiments, the processor 620 of the digital pen 601 may transmit the depress button generated in response to detecting the button input, to the electronic device 801 in operation 941. In various embodiments, the processor 620 of the digital pen 601 may transmit the sensor circuitry activation command to the external electronic device 802, in response to identifying the depress signal as the designated signal of the currently running application.

Referring to FIG. 9D, in operation 942, the processor 820 of the electronic device 801 may activate the audio circuitry 870, in response to receiving the depress signal. In various embodiments, the processor 820 of the electronic device 801 may activate the audio circuitry 870, in response to identifying the depress signal as the designated signal of the currently running application.

Referring to FIG. 9D, in operation 943, the processor 820 of the electronic device 801 may receive an audio signal through the activated audio circuitry 870. In various embodiments, the processor 820 of the electronic device 801 may identify the function indicated by the result of processing the audio signal acquired through the audio circuitry 870 by executing at least one of the client module (e.g., the client module 151 of FIG. 1) or the SDK (e.g., the SDK 153 of FIG. 1), among the functions supported by the currently running application.

Referring to FIG. 9D, in operation 944, the processor 620 of the digital pen 601 may activate the sensor circuitry 699.

Referring to FIG. 9D, in operation 945, the processor 620 of the digital pen 601 may detect a motion by activating the sensor circuitry 699. In various embodiments, the processor 620 of the digital pen 601 may transmit the motion signal corresponding to the detected motion to the electronic device 801 through the communication circuitry 690.

Referring to FIG. 9D, in operation 946, the processor (e.g., the processor 420 of FIG. 4) of the external electronic device 802 may activate the sensor circuitry (e.g., the sensor module 476 of FIG. 4). In various embodiments, the processor (e.g., the processor 420 of FIG. 4) of the external electronic device 802 may activate the sensor circuitry (e.g., the sensor module 476 of FIG. 4), based on the sensor circuitry activation command of the processor 820 of the electronic device 801.

Referring to FIG. 9D, in operation 947, the processor (e.g., the processor 420 of FIG. 4) of the external electronic device 802 may detect a motion by activating the sensor circuitry (e.g., the sensor module 476 of FIG. 4). In various embodiments, the processor (e.g., the processor 42.0 of FIG. 4) of the external electronic device 802 may transmit the motion signal corresponding to the motion detected in operation 947 to the electronic device 801 through the communication circuitry (e.g., the communication module 490 of FIG. 4).

Referring to FIG. 9D, in operation 948, the processor 820 of the electronic device 801 may determine a parameter of the function indicated by the audio signal of operation 943, based on the motion signal of the detected motion of operation 945, the motion signal of the detected motion of operation 947, or their combination. In various embodiments, the processor 820 of the electronic device 801 may determine the parameter of the function indicated by the audio signal of operation 943, based on displacement information of the motion signal of operation 945, displacement information of the motion signal of operation 947, or their combination. In various embodiments, the processor 820 of the electronic device 801 may determine a first parameter of the parameters of the function indicated by the audio signal of operation 943, based on the displacement information of the motion signal of operation 945, and may determine a second parameter of the parameters of the function indicated by the audio signal of operation 943, based on the displacement information of the motion signal of operation 947. In various embodiments, the first parameter and the second parameter may be, but not limited to, of different types. In various embodiments, the first parameter and the second parameter may be of the same type.

In various embodiments, in operation 948, if the currently running application is the external electronic device control application and the function indicated by the audio signal processing result is the volume control function, the processor 820 of the electronic device 801 may determine a first parameter (e.g., the volume value) of the parameters of the volume control function, based on the displacement information of the motion signal of operation 945, and determine a second parameter (e.g., volume up or volume down) of the parameters of the volume control function, based on the displacement information of the motion signal of operation 947.

In various embodiments, if the volume control value indicated by the moving direction, the moving distance, the acceleration, or their combination based on the displacement information of the motion signal of operation 945 is three and the moving direction, the moving distance, the acceleration, or their combination based on the displacement information of the motion signal of operation 947 indicates the volume up, the processor 820 of the electronic device 801 may determine the first parameter (e.g., the volume value) of the parameters of the volume control function indicated by the audio signal processing result among the functions supported by the currently running application, to a volume value changed by three from the current volume value, and determine the second parameter (e.g., the volume up or the volume down) of the parameters of the volume control function, to a volume up value. In various embodiments, the parameter determined based on the motion signal of operation 945 and the parameter determined based on the motion signal of operation 947 may pre-determined from the parameters of the volume control function indicated by the audio signal processing result among the functions supported by the currently running application.

Referring to FIG. 9D, in operation 949, the processor 820 of the electronic device 801 may execute the function of the determined parameter. In various embodiments, by executing the function of the determined parameter in operation 948, the processor 820 of the electronic device 801 may control the currently running application or control the external electronic device which is the control target of the currently running application, in operation 949.

Referring to FIG. 9E, operation 951 may correspond to operation 911 of FIG. 9A, operation 952 may correspond to operation 912 of FIG. 9A, and operation 953 may correspond to operation 913 of FIG. 9A. Operations corresponding to operations 911 through 916 of FIG. 9A, among operations 951 through 955 of FIG. 9E, are described in brief.

Referring to FIG. 9E, in operation 954, the processor 820 of the electronic device 801 may determine a function indicated by the audio signal of operation 953. In various embodiments, the function indicated by the audio signal may further include a name (e.g., a television, an air conditioner, a refrigerator, a speaker) indicating the external electronic device to control, and control content (e.g., a control target function, a control level).

In various embodiments, in operation 954, if the function indicated by the audio signal processing result is the name (e.g., a television) indicating the external electronic device, the control target function g., a volume), and the control level (e.g., 25), the processor 820 of the electronic device 801 may determine a function for controlling the volume of the control target external electronic device indicated by the audio signal of operation 953, to 25.

Referring to FIG. 9E, in operation 955, the processor 820 of the electronic device 801 may execute the determined function. In various embodiments, in operation 955, the processor 820 of the electronic device 801 may control the eternal electronic device to control, by executing the function of the determined parameter of operation 954.

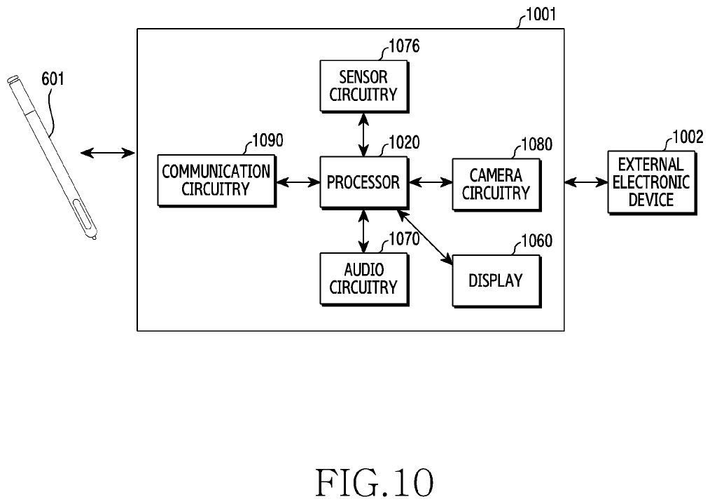

FIG. 10 illustrates a block diagram of an electronic device 1001, a digital pen 601, and an external electronic device 1002 according to various embodiments. In various embodiments, the functional configuration of the electronic device 1001 of FIG. 10 may include the functional configuration of the user terminal 100 of FIG. 1, the functional configuration of the electronic device 401 of FIG. 4, the functional configuration of the electronic device 501 of FIG. 5, or the functional configuration of the electronic device 801 of FIG. 8. In various embodiments, the functional configuration of the digital pen 601 of FIG. 10 may include the functional configuration of the digital pen 601 of FIG. 6 or FIG. 7. In various embodiments, the external electronic device 102 of FIG. 10 may be the electronic device 402 of FIG. 4, the electronic device 404 of FIG. 4, or their combination.

Functions corresponding to the electronic device 801, the digital pen 601, and the external electronic device 802 of FIG. 8, among functions of the electronic device 1001, the digital pen 601, and the external electronic device 1002 of FIG. 10 are described in brief.

Referring to FIG. 10, the electronic device 1001 may include a processor 1020, a display 1060, audio circuitry 1070, sensor circuitry 1076, camera circuitry 1080, communication circuitry 1090, or a combination thereof.

In various embodiments, the functional configuration of the processor 1020 may include the functional configuration of the processor 160 of FIG. 1, the functional configuration of the processor 420 of FIG. 4, or the functional configuration of the processor 820 of FIG. 8. In various embodiments, the functional configuration of the display 1060 may include the functional configuration of the display 140 of FIG. 1 or the functional configuration of the display 460 of FIG. 4. In various embodiments, the functional configuration of the audio circuitry 1070 may include the functional configuration of the microphone 120 of FIG. 1, the functional configuration of the audio module 470 of FIG. 4, or the functional configuration of the audio circuitry 870 of FIG. 8. In various embodiments, the functional configuration of the sensor circuitry 1076 may include the functional configuration of the sensor module 476 of FIG. 4 or the functional configuration of the sensor circuitry 876 of FIG. 8. In various embodiments, the functional configuration of the camera circuitry 1080 may include the functional configuration of the camera module 480 of FIG. 4. In various embodiments, the functional configuration of the communication circuitry 1090 may include the functional configuration of the communication interface 110 of FIG. 1, the functional configuration of the communication module 490 of FIG. 4, or the functional configuration of the communication circuitry 890 of FIG. 8.

In various embodiments, while driving an application for acquiring an image, the processor 1020 of the electronic device 1001 may acquire an image of the external electronic device 1002 using the camera circuitry 1080. In various embodiments, the processor 1020 of the electronic device 1001 may extract an object (or object information) indicating the external electronic device 1002 from the image acquired using the camera circuitry 1080. In various embodiments, the processor 1020 of the electronic device 1001 may transmit the image acquired using the camera circuitry 1080 to a server (e.g., the server 495 of FIG. 4), and obtain object information indicating the external electronic device 1002 from the image, from the server (e.g., the server 495 of FIG. 4). In various embodiments, the object information may include a target model indicated by the object and an area in the image. In various embodiments, the processor 1020 of the electronic device 1001 may execute an application for controlling the external electronic device 1002, based on the object information extracted from the image. In various embodiments, while driving the application for controlling the external electronic device 1002, the processor 1020 of the electronic device 1001 may activate a voice recognition function of the audio circuitry 1070, based on receiving a designated signal from the digital pen 601. In various embodiments, the processor 1020 of the electronic device 1001 may activate the audio circuitry 1070 and receive an audio signal through the audio circuitry 1070. In various embodiments, the processor 1020 of the electronic device 1001 may identify a function indicated by processing the audio signal acquired through the audio circuitry 1070, by executing at least one of the client module (e.g., the client module 151 of FIG. 1) or the SDK (e.g., the SDK 153 of FIG. 1). In various embodiments, the processor 1020 of the electronic device 1001 may control the external electronic device 1002 by executing the function indicated by the audio signal, on the application for controlling the external electronic device 1002.

In various embodiments, a parameter the function indicated by the audio signal may be determined based on the signal generated according to user's depressing the input button (e.g., the trigger circuitry 698), the signal generated by the sensor circuitry (e.g., the sensor circuitry 699) in response to the internal operation state or the external environment state of the digital pen 601, the signal acquired by the communication circuitry (e.g., the communication circuitry 690) from the external electronic device (e.g., the electronic device 402), the audio signal acquired through the audio circuitry 870, the signal generated in response to the internal operation state or the external environment state of the electronic device 801 acquired by the sensor circuitry 876, or a combination thereof.

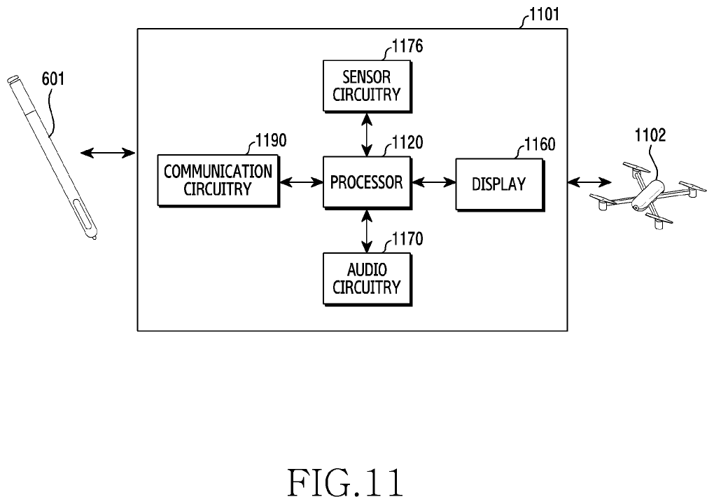

FIG. 11 illustrates a block diagram of an electronic device 1101, a digital pen 601, and an external electronic device 1102 according to various embodiments. In various embodiments, the functional configuration of the electronic device 1101 of FIG. 11 may include the functional configuration of the user terminal 100 of FIG. 1, the functional configuration of the electronic device 401 of FIG. 4, the functional configuration of the electronic device 501 of FIG. 5, or the functional configuration of the electronic device 801 of FIG. 8. In various embodiments, the functional configuration of the digital pen 601 of FIG. 11 may include the functional configuration of the digital pen 601 of FIG. 6 or FIG. 7. In various embodiments, the external electronic device 1102 of FIG. 11 may be the electronic device 404 of FIG. 4, the electronic device 404 of FIG. 4, or their combination.

Functions corresponding to the electronic device 801, the digital pen 601, and the external electronic device 802 of FIG. 8, of the electronic device 1101, the digital pen 601, and the external electronic device 1102 of FIG. 11 are described in brief.

Referring to FIG. 11, the electronic device 1101 may include a processor 1120, a display 1160, audio circuitry 1170, sensor circuitry 1176, communication circuitry 1190, or a combination thereof.

In various embodiments, the functional configuration of the processor 1120 may include the functional configuration of the processor 160 of FIG. 1, the functional configuration of the processor 420 of FIG. 4, or the functional configuration of the processor 820 of FIG. 8. In various embodiments, the functional configuration of the display 1160 may include the functional configuration of the display 140 of FIG. 1 or the functional configuration of the display 460 of FIG. 4. In various embodiments, the functional configuration of the audio circuitry 1170 may include the functional configuration of the microphone 120 of FIG. 1, the functional configuration of the audio module 470 of FIG. 4, or the functional configuration of the audio circuitry 870 of FIG. 8. In various embodiments, the functional configuration of the sensor circuitry 1176 may include the functional configuration of the sensor module 476 of FIG. 4 or the functional configuration of the sensor circuitry 876 of FIG. 8. In various embodiments, the functional configuration of the communication circuitry 1190 may include the functional configuration of the communication interface 110 of FIG. 1, the functional configuration of the communication module 490 of FIG. 4, or the functional configuration of the communication circuitry 890 of FIG. 8.

Referring to FIG. 11, the external electronic device 1102 is an UAV (e.g., a drone), but may be constructed as the external electronic device 1102 of FIG. 11 if including at least two or more controllable components (e.g., a rotor, a camera).

In various embodiments, if the digital pen 601 is attached (e.g., mounted in the receiving space 512 of FIG. 5), the processor 1120 of the electronic device 1101 may execute an application for controlling the external electronic device 1102. In various embodiments, the processor 1120 of the electronic device 1101 may perform functions for determining parameters based on a user's input through the display 1160, a displacement of the electronic device 1101 through the sensor circuitry 1176, or their combination, among functions provided by an application for controlling the external electronic device 1102. In various embodiments, the processor 1120 of the electronic device 1101 may determine a first parameter of a predetermined function among the functions provided by the application for controlling the external electronic device 1102, in response to the user's input through the display 1160. In various embodiments, the processor 1120 of the electronic device 1101 may determine a second parameter of the predetermined function among the functions provided by the application for controlling the external electronic device 1102, in response to the displacement of the electronic device 1101. In various embodiments, the processor 1120 of the electronic device 1101 may control the external electronic device 1102, by executing the function of the determined parameter using the application for controlling the external electronic device 1102. While executing the application for controlling the external electronic device 1102, the processor 1120 of the electronic device 1101 may identify attachment or detachment of the digital pen 601. In various embodiments, if the digital pen 601 is attached or detached, the processor 1120 of the electronic device 1101 may determine at least one of the first parameter or the second parameter of the predetermined function among the functions provided by the application for controlling the external electronic device 1102, in response to the displacement of the digital pen 601.

In various embodiments, while driving the application for controlling the external electronic device 1102, the processor 1120 of the electronic device 1101 may activate a voice recognition function of the audio circuitry 1170, based on receiving a designated signal from the digital pen 601. In various embodiments, the processor 1120 of the electronic device 1101 may receive an audio signal through the activated audio circuitry 1170. In various embodiments, the processor 1120 of the electronic device 1101 may identify a function indicated by processing the audio signal acquired through the audio circuitry 1170, by executing at least one of the client module (e.g., the client module 151 of FIG. 1) or the SDK (e.g., the SDK 153 of FIG. 1). In various embodiments, the processor 1120 of the electronic device 1101 may control the external electronic device 1002, by executing the function indicated by the audio signal, on the application for controlling the external electronic device 1102.

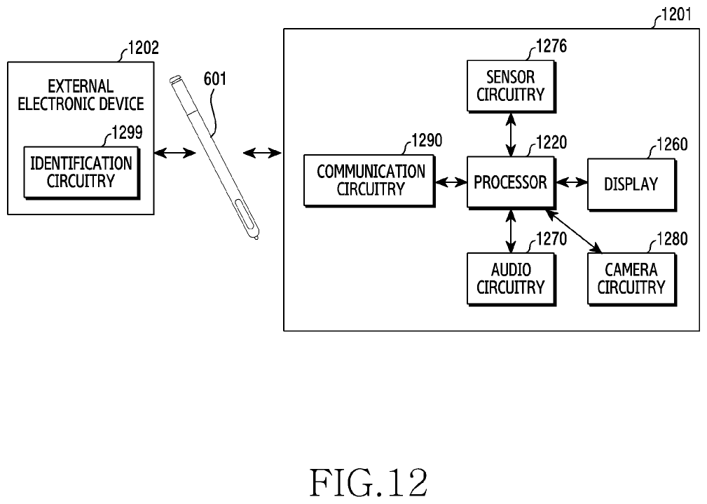

FIG. 12 illustrates a block diagram of an electronic device 1201, a digital pen 601, and an external electronic device 1202 according to various embodiments. In various embodiments, the functional configuration of the electronic device 1201 of FIG. 12 may include the functional configuration of the user terminal 100 of FIG. 1, the functional configuration of the electronic device 401 of FIG. 4, the functional configuration of the electronic device 501 of FIG. 5, or the functional configuration of the electronic device 801 of FIG. 8. In various embodiments, the functional configuration of the digital pen 601 of FIG. 12 may include the functional configuration of the digital pen 601 of FIG. 6 or FIG. 7. In various embodiments, the external electronic device 1202 of FIG. 12 may be the electronic device 402 of FIG. 4, the electronic device 404 of FIG. 4, or their combination.

Functions corresponding to the electronic device 801, the digital pen 601, and the external electronic device 802 of FIG. 8, of the electronic device 1201, the digital pen 601, and the external electronic device 1202 of FIG. 12 are described in brief.

Referring to FIG. 12, the external electronic device 1202 may further include identification circuitry 1299. In various embodiments, the identification circuitry 1299 may include a tag (e.g., an RFID tag) including data readable by the communication circuitry 690 of the digital pen 601 via the antenna 697. In various embodiments, the identification circuitry 1299 may be communication circuitry (e.g., the communication module 490 of FIG. 4) for transmitting and receiving data to and from the communication circuitry 690 of the digital pen 601. In various embodiments, the external electronic device 1202 may further include a receiving space (not shown, e.g., the receiving space 512 of FIG. 5) for accommodating the digital pen 601. In various embodiments, if the digital pen 601 is received in the external electronic device 1202, the external electronic device 1202 may transmit data of the external electronic device 1202 to the digital pen 601 through the identification circuitry 1299. In various embodiments, the data of the external electronic device 1292 may include an identifier of the external electronic device 1202, accessory information, or their combination.

Referring to FIG. 12, the electronic device 1201 may include a processor 1220, a display 1260, audio circuitry 1270, sensor circuitry 1276, camera circuitry 1280, communication circuitry 1290, or a combination thereof.

In various embodiments, the functional configuration of the processor 1220 may include the functional configuration of the processor 160 of FIG. 1, the functional configuration of the processor 420 of FIG. 4, or the functional configuration of the processor 820 of FIG. 8. In various embodiments, the functional configuration of the display 1260 may include the functional configuration of the display 140 of FIG. 1, the functional configuration of the display device 460 of FIG. 4, or the functional configuration of the display 860 of FIG. 8. In various embodiments, the functional configuration of the audio circuitry 1270 may include the functional configuration of the microphone 120 of FIG. 1, the functional configuration of the audio module 470 of FIG. 4, or the functional configuration of the audio circuitry 870 of FIG. 8. In various embodiments, the functional configuration of the sensor circuitry 1276 may include the functional configuration of the sensor module 476 of FIG. 4 or the functional configuration of the sensor circuitry 876 of FIG. 8. In various embodiments, the functional configuration of the communication circuitry 1290 may include the functional configuration of the communication interface 110 of FIG. 1, the functional configuration of the communication module 490 of FIG. 4, or the functional configuration of the communication circuitry 890 of FIG. 8.

In various embodiments, while driving an application, the processor 1220 of the electronic device 1201 may receive data of the external electronic device 1202 from the digital pen 601. In various embodiments, while driving the application, the processor 1220 of the electronic device 1201 may identify the external electronic device 1202, based on the data of the external electronic device 1202 received from the digital pen 601. In various embodiments, while driving the application, the processor 1220 of the electronic device 1201 may determine a weight corresponding to the identified external electronic device 1202. In various embodiments, the processor 1220 of the electronic device 1201 may determine a weight of a parameter for a function selected based on the data of the external electronic device 1202 among functions provided by the application.

In various embodiments, while driving the application, the processor 1220 of the electronic device 1201 may activate a voice recognition function of the audio circuitry 1270, based on receiving a designated signal from the digital pen 601. In various embodiments, the processor 1220 of the electronic device 1201 may receive an audio signal through the activated audio circuitry 1270. In various embodiments, the processor 1220 of the electronic device 1201 may identify a function indicated by a processing result of the audio signal acquired through the audio circuitry 1270 by executing at least one of the client module (e.g., the client module 151 of FIG. 1) or the SDK (e.g., the SDK 153 of FIG. 1). In various embodiments, the processor 1220 of the electronic device 1201 may control the external electronic device 1202, by executing the function indicated by the audio signal, on the application for controlling the external electronic device 1202.

In various embodiments, the parameter of the function indicated by the audio signal may be determined based on the signal generated according to user's depressing the input button (e.g., the trigger circuitry 698), the signal generated by the sensor circuitry (e.g., the sensor circuitry 699) in response to the internal operation state or the external environment state of the digital pen 601, the signal acquired by the communication circuitry (e.g., the communication circuitry 690) from the external electronic device (e.g., the electronic device 402), the audio signal acquired through the audio circuitry 870, the signal generated in response to the internal operation state or the external environment state of the electronic device 801 acquired by the sensor circuitry 876, or a combination thereof. In various embodiments, the parameter of the function indicated by the audio signal may be determined based on the weight of the parameter of the function indicated by the audio signal.

As set forth above, based on the designated input received from the digital pen 601, the electronic device 801 according to various embodiments may activate the audio circuitry, receive the audio signal, identify the function indicated by the received audio signal, determine the parameter of the identified function based on the input received from the digital pen 601, and thus precisely execute the function based on a user's intention by use of the digital pen 601.

As above, an electronic device (e.g., the electronic device 801) according to various embodiments may include a housing, a microphone exposed through a part of the housing, at least one wireless communication circuitry disposed to be attached or detached inside the housing and configured to wirelessly connect with a stylus pen which includes a button, a processor disposed in the housing and operatively coupled with the microphone and the wireless communication circuitry, and a memory disposed in the housing, operatively coupled with the processor, and storing instructions, when executed, which cause the processor to receive a first radio signal transmitted based on a user input to the button from the stylus pen through the wireless communication circuitry, activate a voice recognition function of the microphone in response to receiving the first radio signal, receive an audio signal from a user through the microphone, recognize the received audio signal using the activated voice recognition function, and execute a function indicated by the audio signal, based at least in part on the recognition result.

In various embodiments, the stylus pen may further include a first motion sensor for generating first motion information indicating a motion of the stylus pen, and the instructions may cause the processor to receive a second radio signal related to the first motion information of the stylus pen from the stylus pen through the wireless communication circuitry, identify the first motion information of the stylus pen, based at least in part on the received second radio signal, determine a first parameter related to the function indicated by the audio signal, based at least in part on the identified first motion information, and execute the function, based at least in part on the first parameter determined.

In various embodiments, the first motion information of the stylus pen may include at least one of a tilt, a moving distance, or a moving direction of the stylus pen.

In various embodiments, the stylus pen may be configured to transmit the second radio signal, by transmitting the first radio signal based on the user input to the button of the stylus pen and then detecting a first motion of the stylus pen using the motion sensor.

In various embodiments, the communication circuitry may be configured to transmit a control signal for controlling an external electronic device to communication circuitry of the external electronic device, and the instructions may cause the processor to generate the control signal corresponding to the indicated function, and transmit the control signal to the external electronic device through the wireless communication circuitry.

In various embodiments, the electronic device may further include a second motion sensor for generating second motion information indicating a motion of the electronic device, and the instructions may cause the processor to identify the second motion information of the electronic device generated by the second motion sensor of the electronic device, and determine a second parameter of the indicated function, based at least in part on the identified second motion information.

In various embodiments, the electronic device may further include input circuitry integrally coupled with the electronic device and receiving the user input, and the instructions may cause the processor to identify the user input received through input circuitry, and determine a second parameter of the indicated function, based at least in part on the identified input.

In various embodiments, the communication circuitry may be configured to receive an identifier of an external electronic device to which the stylus pen is attached, from the communication circuitry of the stylus pen, and the instructions may cause the processor to determine a first parameter of the indicated function, based at least in part on the identifier of the external electronic device received from the stylus pen.

In various embodiments, the instructions may cause the processor to, after activating the voice recognition function, identify the number of receptions of the first radio signal from the stylus pen, determine a first parameter of a function indicated by the audio signal, based at least in part on the number of the receptions, and execute the function based at least in part on the first parameter determined.

In various embodiments, the communication circuitry may be configured to transmit a control signal for controlling an external electronic device, to communication circuitry of the external electronic device, and the instructions may cause the processor to request motion information indicating a motion of the external electronic device from the external electronic device, in response to receiving the first radio signal, receive a third radio signal related to third motion information from the external electronic device through the wireless communication circuitry, identify third motion information of the external electronic device, based at least in part on the received third radio signal, determine a first parameter related to a function indicated by the audio signal, based at least in part on the identified third motion information, and execute the function, based at least n part on the first parameter determined.

A method for operating an electronic device (e.g., the electronic device 801) according to various embodiments may include receiving, a first radio signal transmitted based on a user input to a button from a stylus pen which is detachably disposed in a housing of the electronic device and includes the button, through wireless communication circuitry of the electronic device, activating a voice recognition function of a microphone exposed through a part of the housing of the electronic device, in response to receiving the first radio signal, receiving an audio signal from a user through the microphone, based on the activated recognition function, recognizing the received audio signal using the activated voice recognition function, and executing a function indicated by the audio signal, based at least in part on the recognition result.

In various embodiments, the stylus pen may further include a first motion sensor for generating first motion information indicating a motion of the stylus pen, and the method may further include receiving a second radio signal related to the first motion information of the stylus pen from the stylus pen through the wireless communication circuit, identifying the first motion information of the stylus pen, based at least in part on the received second radio signal, determining a first parameter related to the function indicated by the audio signal, based at least in part on the identified first motion information, and executing the function, based at least in part on the first parameter determined.

In various embodiments, the first motion information of the stylus pen may include at least one of a tilt, a moving distance, or a moving direction of the stylus pen.

In various embodiments, the stylus pen may be configured to transmit the second radio signal, by transmitting the first radio signal based on the user input to the button of the stylus pen and then detecting a first motion of the stylus pen using a motion sensor.

In various embodiments, the communication circuitry may be configured to transmit a control signal for controlling an external electronic device to communication circuitry of the external electronic device, and the method may further include generating the control signal corresponding to the indicated function, and transmitting the generated control signal to the external electronic device through the wireless communication circuitry.

In various embodiments, the method may further include identifying second motion information of the electronic device generated by a second motion sensor of the electronic device, and determining a second parameter of the indicated function, based at least in part on the identified second motion information.

In various embodiments, the method may further include identifying the user input received through an input circuitry which is integrally coupled with the electronic device, and determining another parameter of the indicated function, based at least in part on the identified input.

In various embodiments, the method may further include receiving an identifier of an external electronic device to which the input device is attached, from the stylus pen through the communication circuitry, and determining a first parameter of the indicated function, based at least in part on the identifier of the external electronic device received from the stylus pen.

In various embodiments, the method may further include, after activating the voice recognition function, identifying the number of receptions of the first radio signal from the stylus pen, determining a first parameter of the function indicated by the audio signal, based at least in part on the number of the receptions, and executing the function based at least in part on the first parameter determined.

In various embodiments, the method may further include requesting motion information indicating a motion of the external electronic device from the external electronic device, in response to receiving the first radio signal, receiving a third radio signal related to third motion information from the external electronic device through the wireless communication circuitry, identifying third motion information of the external electronic device, based at least in part on the received third radio signal, determining a first parameter related to the function indicated by the audio signal, based at least in part on the identified third motion information, and executing the function, based at least in part on the first parameter determined.

An electronic device and a method according to various embodiments may identify a function based on an input received from an input tool, determine a parameter of the identified function based on the input received from the input tool, and thus precisely execute a function according to a user's intention using the input tool.

Methods of embodiments mentioned in the claims or specification of the disclosure may be implemented in the form of hardware, software, or a combination of the hardware and the software.

In response to being implemented by the software, a computer-readable storage media storing one or more programs (i.e., software modules) may be provided. The one or more programs stored in the computer-readable storage media are configured to be executable by one or more processors within an electronic device. The one or more programs include instructions for enabling the electronic device to execute the methods of the embodiments stated in the claims or specification of the disclosure.

These programs (i.e., software modules and/or software) may be stored in a random access memory (RAM), a non-volatile memory including a flash memory, a read only memory (ROM), an electrically erasable programmable ROM (EEPROM), a magnetic disc storage device, a compact disc-OM (CD-ROM), digital versatile discs (DVDs), an optical storage device of another form, and/or a magnetic cassette. Or, the programs may be stored in a memory that is constructed in combination of some or all of them. Also, each constructed memory may be included in plural as well.

Also, the program may be stored in an attachable storage device that may access through a communication network such as the Internet, an intranet, a local area network (LAN), a wireless LAN (WLAN) or a storage area network (SAN), or a communication network configured in combination of them. This storage device may connect to a device performing an embodiment of the disclosure through an external port. Also, a separate storage device on the communication network may connect to the device performing the embodiment of the disclosure as well.

In the above-described concrete embodiments of the disclosure, constituent elements included in the disclosure have been expressed in the singular or plural according to a proposed concrete embodiment. But, the expression of the singular or plural is selected suitable to a given situation for the sake of description convenience, and the disclosure is not limited to singular or plural constituent elements. Even a constituent element expressed in the plural may be constructed in the singular, or even a constituent element expressed in the singular may be constructed in the plural.

An electronic device of various embodiments and a method performed by the electronic device may sort a plurality of items on the basis of a feature of a visual object selected by a user.

While the disclosure has been shown and described with reference to various embodiments thereof, it will be understood by those skilled in the art that various changes in form and details may be made therein without departing from the spirit and scope of the disclosure as defined by the appended claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a housing;
a microphone exposed through a part of the housing;
at least one wireless communication circuitry disposed to be attached or detached inside the housing and configured to wirelessly connect with a stylus pen, the stylus pen comprising a button;
a processor disposed in the housing and operatively coupled with the microphone and the at least one wireless communication circuitry; and
a memory disposed in the housing, operatively coupled with the processor, and storing instructions, then executed, which cause the processor to:
receive, through the wireless communication circuitry, a first radio signal transmitted based on a user input to the button from the stylus pen,
activate a voice recognition function of the microphone in response to receiving the first radio signal,
receive an audio signal from a user through the microphone,
recognize the received audio signal using the activated voice recognition function, and
execute a function indicated by the audio signal, based at least in part on the voice recognition result.

2. The electronic device of claim 1, wherein the stylus pen further comprises:
a first motion sensor for generating first motion information indicating a motion of the stylus pen,
wherein the instructions cause the processor to:
receive a second radio signal related to the first motion information of the stylus pen from the stylus pen through the wireless communication circuitry,
identify the first motion information of the stylus pen, based at least in part on the received second radio signal,
determine a first parameter related to the function indicated by the audio signal, based at least in part on the identified first motion information, and
execute the function indicated by the audio signal, based at least in part on the determined first parameter.

3. The electronic device of claim 2, wherein the first motion information of the stylus pen comprises at least one of a tilt, a moving distance, or a moving direction of the stylus pen.

4. The electronic device of claim 2, wherein the stylus pen is configured to transmit the second radio signal, by transmitting the first radio signal based on the user input to the button of the stylus pen and then detecting a first motion of the stylus pen using the first motion sensor.

5. The electronic device of claim 2, wherein the at least one wireless communication circuitry is configured to transmit a control signal for controlling an external electronic device to communication circuitry of the external electronic device,
wherein the instructions cause the processor to:
generate the control signal corresponding to the function indicated by the audio signal, and
transmit the generated control signal to the external electronic device through the wireless communication circuitry.

6. The electronic device of claim 5, further comprising:
a second motion sensor for generating second motion information indicating a second motion of the electronic device,
wherein the instructions cause the processor to:
identify the second motion information of the electronic device generated by the second motion sensor of the electronic device, and
determine a second parameter of the function indicated by the audio signal, based at least in part on the identified second motion information.

7. The electronic device of claim 5, further comprising:
input circuitry coupled with the electronic device and receiving the user input,
wherein the instructions cause the processor to:
identify the user input received through the input circuitry, and
determine a second parameter of the function indicated by the audio signal, based at least in part on the identified user input.

8. The electronic device of claim 1, wherein:
the at least one wireless communication circuitry is configured to receive an identifier of an external electronic device to which the stylus pen is attached, from the at least one wireless communication circuitry of the stylus pen, and
the instructions cause the processor to determine a first parameter of the function indicated by the audio signal, based at least in part on the identifier of the external electronic device received from the stylus pen.

9. The electronic device of claim 1, wherein the instructions cause the processor to:
after activating the voice recognition function, identify a number of receptions of the first radio signal from the stylus pen,
determine a first parameter of a function indicated by the audio signal, based at least in part on the number of the receptions, and
execute the function indicated by the audio signal based at least in part on the first parameter determined.

10. The electronic device of claim 1, wherein the at least one wireless communication circuitry is configured to transmit a control signal for controlling an external electronic device, to communication circuitry of the external electronic device, and
the instructions cause the processor to:
request motion information indicating a motion of the external electronic device from the external electronic device, in response to receiving the first radio signal,
receive a third radio signal related to third motion information from the external electronic device through the wireless communication circuitry,
identify third motion information of the external electronic device, based at least in part on the received third radio signal,
determine a first parameter related to a function indicated by the audio signal, based at least in part on the identified third motion information, and
execute the function indicated by the audio signal, based at least in part on the determined first parameter.

11. A method for operating an electronic device, comprising:
receiving through wireless communication circuitry of the electronic device, a first radio signal transmitted based on a user input to a button from a stylus pen which is detachably disposed in a housing of the electronic device, the stylus pen comprising the button;
activating a voice recognition function of a microphone exposed through a part of the housing of the electronic device, in response to receiving the first radio signal;
receiving an audio signal from a user through the microphone, based on the activated voice recognition function;
recognizing the received audio signal using the activated voice recognition function; and
executing a function indicated by the audio signal, based at least in part on the voice recognition result.

12. The method of claim 11, wherein the stylus pen further comprises a first motion sensor for generating first motion information indicating a motion of the stylus pen, further comprising:
receiving a second radio signal related to the first motion information of the stylus pen from the stylus pen through the wireless communication circuitry;
identifying the first motion information of the stylus pen, based at least in part on the received second radio signal;
determining a first parameter related to the function indicated by the audio signal, based at least in part on the identified first motion information; and
executing the function indicated by the audio signal, based at least in part on the determined first parameter.

13. The method of claim 12, wherein the first motion information of the stylus pen comprises at least one of a tilt, a moving distance, or a moving direction of the stylus pen.

14. The method of claim 12, wherein the stylus pen is configured to transmit the second radio signal, by transmitting the first radio signal based on the user input to the button of the stylus pen and then detecting a first motion of the stylus pen using a motion sensor.

15. The method of claim 12, wherein the wireless communication circuitry is configured to transmit a control signal for controlling an external electronic device to communication circuitry of the external electronic device, further comprising:
generating the control signal corresponding to the function indicated by the audio signal; and
transmitting the generated control signal to the external electronic device through the wireless communication circuitry.

16. The method of claim 15, further comprising:
identifying second motion information of the electronic device generated by a second motion sensor of the electronic device; and
determining a second parameter of the function indicated by the audio signal, based at least in part on the identified second motion information.

17. The method of claim 15, further comprising:
identifying the user input received through an input circuitry which is coupled with the electronic device; and
determining another parameter of the function indicated by the audio signal, based at least in part on the identified user input.

18. The method of claim 11, further comprising:
receiving an identifier of an external electronic device to which an input device is attached, from the stylus pen through the wireless communication circuitry; and
determining a first parameter of the function indicated by the audio signal, based at least in part on the identifier of the external electronic device received from the stylus pen.

19. The method of claim 11, further comprising:
after activating the voice recognition function, identifying a number of receptions of the first radio signal from the stylus pen;
determining a first parameter of the function indicated by the audio signal, based at least in part on the number of the receptions; and
executing the function indicated by the audio signal based at least in part on the first parameter determined.

20. The method of claim 11, further comprising:
requesting motion information indicating a motion of an external electronic device from the external electronic device, in response to receiving the first radio signal;
receiving a third radio signal related to third motion information from the external electronic device through the wireless communication circuitry;
identifying third motion information of the external electronic device, based at least in part on the received third radio signal;
determining a first parameter related to the function indicated by the audio signal, based at least in part on the identified third motion information; and
executing the function indicated by the audio signal, based at least in part on the determined first parameter.
